(19) United States
(12) Patent Application Publication
(10) Pub. No.: US 2021/0321320 A1
(43) Pub. Date: Oct. 14, 2021

(54) METHOD AND APPARATUS FOR TRANSMITTING DATA IN WIRELESS COMMUNICATION SYSTEM

(71) Applicant: LG ELECTRONICS INC., Seoul (KR)

(72) Inventor: Sungduck CHUN, Seoul (KR)

(73) Assignee: LG ELECTRONICS INC., Seoul (KR)

(21) Appl. No.: 17/260,197

(22) PCT Filed: Jul. 17, 2019
(86) PCT No.: PCT/KR2019/008814

§ 371 Date: Jan. 13, 2021

(30) Foreign Application Priority Data
Jul. 18, 2018 (KR) 10-2018-0083488

(51) Int. Cl. H04W 48/02; H04W 24/08; H04W 8/24

(52) U.S. Cl. CPC H04W 48/02; H04W 16/14; H04W 8/24; H04W 24/08

(57) ABSTRACT

Disclosed are a method for transmitting data in a wireless communication system and an apparatus therefor. Specifically, an aspect of the present disclosure, in a method for transmitting data of a terminal in a wireless communication system, includes transmitting a maximum data usage value configured in the terminal to a first node of a network; receiving configuration update information from the first node when a data usage value measured at a second node of the network reaches the maximum data usage value; and updating a configuration related to data transmission based on the configuration update information, wherein the configuration update information may be information received when a communication environment is reconfigured by a core network, and configurations of nodes included in the network are changed based on the communication environment.

### TECHNICAL FIELD

The present disclosure relates to a wireless communication system, and to a method and apparatus for transmitting/receiving data.

### BACKGROUND ART

Wireless communication systems are being widely deployed to provide various types of communication services such as voice and data. In general, the wireless communication system is a multiple access system capable of supporting communication with multiple users by sharing available system resources (bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, a multi carrier frequency division multiple access (MC-FDMA) system, and the like.

Various devices and technologies such as smartphones and tablet PCs that require 1³1 machine-to-machine (M2M) communication and high data transmission volume have emerged and spread. Accordingly, the amount of data required to be processed in a cellular network is increasing very rapidly. In order to satisfy such rapidly increasing data processing requirements, carrier aggregation technology, cognitive radio technology, etc. to efficiently use more frequency bands, and multiple antenna technology, multiple base station cooperation technology to increase the data capacity transmitted within a limited frequency are developing.

On the other hand, the communication environment is evolving in the direction of increasing the density of nodes that user equipment (UE) can access in the vicinity. A node refers to a fixed point at which one or more antennas are provided to transmit/receive radio signals to and from the UE. A communication system having a high density node can provide a higher performance communication service to the UE by cooperation between nodes.

### DETAILED DESCRIPTION OF INVENTION

### Technical Problem

An object of the present disclosure is to propose a method for effectively transmitting data by a terminal in a wireless communication system.

In addition, an object of the present disclosure is to provide a method for measuring the data usage of a terminal in a network, and for effectively transmitting data by the terminal in a wireless communication system through this.

Technical problems to be achieved by the present disclosure are not limited to the aforementioned technical problems, and other technical problems not described above may be evidently understood by those of ordinary skill in the art to which the present disclosure belongs from the following description.

### Technical Solution

An aspect of the present disclosure, in a method for transmitting data of a terminal in a wireless communication system, includes transmitting a maximum data usage value configured in the terminal to a first node of a network; receiving configuration update information from the first node when a data usage value measured at a second node of the network reaches the maximum data usage value; and updating a configuration related to data transmission based on the configuration update information, wherein the configuration update information may be information received when a communication environment is reconfigured by a core network, and configurations of nodes included in the network are changed based on the communication environment.

In addition, the terminal may communicate using an unlicensed band or wireless fidelity (Wi-fi).

In addition, the configuration change of the nodes included in the network may be for prohibiting the data transmission to the terminal using a mobile network, or for allowing only the data transmission using the unlicensed band.

In addition, the configuration update information may include quality of service (QoS) information of a provided communication service or the measured data usage value.

In addition, the QoS information may include information notifying that quality of a communication service may be deteriorated due to the use of the unlicensed band.

In addition, the configuration related to the data transmission may be for blocking the data transmission via up-link.

In addition, the method may further include transmitting information on an access method indicating a wireless access technology applicable for use of a communication service to the first node.

In addition, a connection between the terminal and the network may be configured by the first node based on the information on the access method.

In addition, the terminal may receive a result of the connection configuration between the terminal and the network from the first node.

In addition, the reconfiguration for the communication environment may transmit information to a policy and charging rule function (PCRF) or an online charging system (OCS)/offline charging system (OFCS) node.

In addition, the second node may be a packet data network gateway (P-GW) or a node related with a charging system.

In addition, the information on the access method may include a priority value for a wireless access technology that can be applied to use the communication service.

In addition, the transmitting information on the access method may be transmitted in a radio resource control (RRC) connection procedure(process) with a base station or in a service request procedure(process) with the first node.

Another aspect of the present disclosure, in a terminal for transmitting data in a wireless communication system, includes a communication module; a display unit; a memory; and a processor configured to control the communication module, the display unit, and the memory, wherein the processor is configured to: transmit a maximum data usage value stored in the memory to a first node of a network through the communication module; receive configuration update information from the first node through the communication module when a data usage value measured at a second node of the network reaches the maximum data usage value; and update a configuration related to data use based on the configuration update information, wherein the configuration update information may be information received when a communication environment is reconfigured by a core network, and configurations of nodes included in the network are changed based on the communication environment.

In addition, the processor may communicate using an unlicensed band or wireless fidelity (Wi-fi) through the communication module.

In addition, the configuration change of nodes included in the network may be for prohibiting the data transmission to the terminal using a mobile network, or for allowing only the data transmission using the unlicensed band.

In addition, the configuration related to the data use may be for blocking the data transmission via up-link.

In addition, the processor may transmit information on an access method indicating a wireless access technology applicable for use of a communication service to the first node through the communication module.

In addition, the processor may receive a result of the connection configuration between the terminal and the network by the first node based on the information on the access method through the communication module.

### Advantageous Effects

According to an embodiment of the present disclosure, a terminal can effectively transmit data in a wireless communication system.

In addition, according to an embodiment of the present disclosure, it is possible to provide a method for measuring the data usage of a terminal in a network, and for effectively transmitting data by the terminal in a wireless communication system through this.

The effects obtained in the present disclosure are not limited to the above-mentioned effects, and other effects not mentioned will be clearly understood by those of ordinary skill in the art to which the present disclosure belongs from the following description.

### DESCRIPTION OF DRAWINGS

FIG. 1 illustrates an AI device according to an embodiment of the present disclosure.

FIG. 2 illustrates an AI server according to an embodiment of the present disclosure.

FIG. 3 illustrates an AI system according to an embodiment of the present disclosure.

FIG. 4 is a diagram illustrating a schematic structure of an Evolved Packet System (EPS) including an Evolved Packet Core (EPC).

FIG. 5 is an exemplary diagram illustrating architecture of a general E-UTRAN and EPC.

FIG. 6A is an example of a case in which NR, that is, only 5G radio access technology is additionally used in an existing EPS system.

FIG. 6B is an example of a case in which an LTE radio connection is additionally added in a situation in which NG RAN and NGC are utilized.

FIG. 6C is a block diagram of a 5G architecture applicable to the present disclosure.

FIG. 7 is an exemplary diagram illustrating a structure of a radio interface protocol in a control plane.

FIG. 8 is an exemplary diagram illustrating a structure of a radio interface protocol in a user plane.

FIG. 9 illustrates Long Term Evolution (LTE) protocol stacks for a user plane and a control plane.

FIG. 10 is a flowchart illustrating a random access procedure.

FIG. 11 illustrates a connection procedure in a radio resource control (RRC) layer.

FIG. 12 illustrates a flow of (downlink/uplink) signals between a UE and a network node(s) in a conventional system.

FIG. 13 illustrates a flow of (downlink/uplink) signals between a UE and a network node(s) in an improved system to which the present disclosure is applied.

FIG. 14 is a diagram illustrating a case in which a user blocks data use when a configured maximum usage is reached according to an embodiment of the present disclosure.

FIG. 15 is a diagram illustrating a case in which a user blocks data use according to an embodiment of the present disclosure.

FIG. 16 is a diagram illustrating a case in which a user blocks data use when a configured maximum usage is reached according to an embodiment of the present disclosure.

FIG. 17 illustrates a procedure of transmitting/receiving data according to the present disclosure.

FIG. 18 illustrates another example of a procedure of transmitting/receiving data according to the present disclosure.

FIG. 19 is a diagram illustrating a configuration of a node device applied to a proposal of the present disclosure.

### MODE FOR INVENTION

The terms used in the present disclosure have been selected from general terms that are currently widely used while considering the functions of the present disclosure, but this may vary depending on the intention of technicians working in the field, or precedents, the emergence of new technologies, etc. In addition, in certain cases, there are terms arbitrarily selected by the applicant, and in this case, the meaning of the terms will be described in detail in the description of the corresponding invention. Therefore, the terms used in the present disclosure should be defined based on the meaning of the term and the overall contents of the present disclosure, not a simple name of the term.

The following embodiments are a combination of elements and features of the present disclosure in a predetermined form. Each element or feature may be considered optional unless otherwise explicitly stated. Each element or feature may be implemented in a form that is not combined with other elements or features. In addition, some elements and/or features may be combined to constitute an embodiment of the present disclosure. The order of operations described in the embodiments of the present disclosure may be changed. Some configurations or features of one embodiment may be included in other embodiments, or may be replaced with corresponding configurations or features of other embodiments.

In the description of the drawings, procedures or steps that may obscure the subject matter of the present disclosure are not described, and procedures or steps that can be understood by those skilled in the art have not been described.

Throughout the specification, when a part is said to “comprising or including” a certain element, this means that it does not exclude other elements but may further include other elements unless otherwise stated. In addition, terms such as “ . . . unit”, “ . . . group”, and “module” described in the specification mean a unit that processes at least one function or operation, and this may be implemented in hardware or software or a combination of hardware and software. In addition, “a or an”, “one”, “the” and similar related words may be used in a sense of including both the singular and the plural unless otherwise indicated in the present disclosure or clearly contradicted by context, in the context describing the present disclosure (in particular, in the context of the following claims).

Embodiments of the present disclosure may be incorporated by reference by standard documents disclosed in at least one of the IEEE 802.xx system, 3GPP system, 3GPP LTE system, and 3GPP2 system as wireless access systems. That is, obvious steps or parts not described among the embodiments of the present disclosure may be described with reference to the above documents.

In addition, all terms disclosed in this document may be explained by the above standard document. For example, the present disclosure may be incorporated by reference by one or more of the standard documents of 3GPP TS 36.211, 3GPP TS 36.213, 3GPP TS 36.321, 3GPP TS 36.322, 3GPP TS 36.323, 3GPP TS 36.331, 3GPP TS 23.203, 3GPP TS 23.401, 3GPP TS 24.301, 3GPP TS 23.228, 3GPP TS 29.228, 3GPP TS 23.218, 3GPP TS 22.011, 3GPP TS 36.413.

Hereinafter, preferred embodiments according to the present disclosure will be described in detail with reference to the accompanying drawings. The detailed description to be disclosed hereinafter together with the accompanying drawings is intended to describe exemplary embodiments of the present disclosure and is not intended to represent the only embodiments in which the present disclosure may be implemented.

In addition, specific terms used in the embodiments of the present disclosure are provided to help the understanding of the present disclosure, and the use of these specific terms may be changed in other forms without departing from the technical spirit of the present disclosure.

A base station in this document is regarded as a terminal node of a network, which performs communication directly with a UE. In this document, particular operations regarded to be performed by the base station may be performed by an upper node of the base station depending on situations. In other words, it is apparent that in a network consisting of a plurality of network nodes including a base station, various operations performed for communication with a UE may be performed by the base station or by network nodes other than the base station. The term Base Station (BS) may be replaced with a fixed station, Node B, evolved-NodeB (eNB), Base Transceiver System (BTS), or Access Point (AP). Also, a terminal may be fixed or mobile; and the term may be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter may be part of the base station, and a receiver may be part of the terminal. Similarly, in uplink transmission, a transmitter may be part of the terminal, and a receiver may be part of the base station.

3GPP LTE/LTE-A/NR is primarily described for clear description, but technical features of the present invention are not limited thereto.

Three major requirement areas of 5G include (1) an enhanced mobile broadband (eMBB) area, (2) a massive machine type communication (mMTC) area and (3) an ultra-reliable and low latency communications (URLLC) area.

Some use cases may require multiple areas for optimization, and other use case may be focused on only one key performance indicator (KPI). 5G support such various use cases in a flexible and reliable manner.

eMBB is far above basic mobile Internet access and covers media and entertainment applications in abundant bidirectional tasks, cloud or augmented reality. Data is one of key motive powers of 5G, and dedicated voice services may not be first seen in the 5G era. In 5G, it is expected that voice will be processed as an application program using a data connection simply provided by a communication system. Major causes for an increased traffic volume include an increase in the content size and an increase in the number of applications that require a high data transfer rate. Streaming service (audio and video), dialogue type video and mobile Internet connections will be used more widely as more devices are connected to the Internet. Such many application programs require connectivity always turned on in order to push real-time information and notification to a user. A cloud storage and application suddenly increases in the mobile communication platform, and this may be applied to both business and entertainment. Furthermore, cloud storage is a special use case that tows the growth of an uplink data transfer rate. 5G is also used for remote business of cloud. When a tactile interface is used, further lower end-to-end latency is required to maintain excellent user experiences. Entertainment, for example, cloud game and video streaming are other key elements which increase a need for the mobile broadband ability. Entertainment is essential in the smartphone and tablet anywhere including high mobility environments, such as a train, a vehicle and an airplane. Another use case is augmented reality and information search for entertainment. In this case, augmented reality requires very low latency and an instant amount of data.

Furthermore, one of the most expected 5G use case relates to a function capable of smoothly connecting embedded sensors in all fields, that is, mMTC. Until 2020, it is expected that potential IoT devices will reach 20.4 billions. The industry IoT is one of areas in which 5G performs major roles enabling smart city, asset tracking, smart utility, agriculture and security infra.

URLLC includes a new service which will change the industry through remote control of major infra and a link having ultra reliability/low available latency, such as a self-driving vehicle. A level of reliability and latency is essential for smart grid control, industry automation, robot engineering, drone control and adjustment.

Multiple use cases are described more specifically.

5G may supplement fiber-to-the-home (FTTH) and cable-based broadband (or DOCSIS) as means for providing a stream evaluated from gigabits per second to several hundreds of mega bits per second. Such fast speed is necessary to deliver TV with resolution of 4K or more (6K, 8K or more) in addition to virtual reality and augmented reality. Virtual reality (VR) and augmented reality (AR) applications include immersive sports games. A specific application program may require a special network configuration. For example, in the case of VR game, in order for game companies to minimize latency, a core server may need to be integrated with the edge network server of a network operator.

An automotive is expected to be an important and new motive power in 5G, along with many use cases for the mobile communication of an automotive. For example, entertainment for a passenger requires a high capacity and a high mobility mobile broadband at the same time. The reason for this is that future users continue to expect a high-quality connection regardless of their location and speed. Another use example of the automotive field is an augmented reality dashboard. The augmented reality dashboard overlaps and displays information, identifying an object in the dark and notifying a driver of the distance and movement of the object, over a thing seen by the driver through a front window. In the future, a wireless module enables communication between automotives, information exchange between an automotive and a supported infrastructure, and information exchange between an automotive and other connected devices (e.g., devices accompanied by a pedestrian). A safety system guides alternative courses of a behavior so that a driver can drive more safely, thereby reducing a danger of an accident. A next step will be a remotely controlled or self-driven vehicle. This requires very reliable, very fast communication between different self-driven vehicles and between an automotive and infra. In the future, a self-driven vehicle may perform all driving activities, and a driver will be focused on things other than traffic, which cannot be identified by an automotive itself. Technical requirements of a self-driven vehicle require ultra-low latency and ultra-high speed reliability so that traffic safety is increased up to a level which cannot be achieved by a person.

A smart city and smart home mentioned as a smart society will be embedded as a high-density radio sensor network. The distributed network of intelligent sensors will identify the cost of a city or home and a condition for energy-efficient maintenance. A similar configuration may be performed for each home. All of a temperature sensor, a window and heating controller, a burglar alarm and home appliances are wirelessly connected. Many of such sensors are typically a low data transfer rate, low energy and a low cost. However, for example, real-time HD video may be required for a specific type of device for surveillance.

The consumption and distribution of energy including heat or gas are highly distributed and thus require automated control of a distributed sensor network. A smart grid collects information, and interconnects such sensors using digital information and a communication technology so that the sensors operate based on the information. The information may include the behaviors of a supplier and consumer, and thus the smart grid may improve the distribution of fuel, such as electricity, in an efficient, reliable, economical, production-sustainable and automated manner. The smart grid may be considered to be another sensor network having small latency.

A health part owns many application programs which reap the benefits of mobile communication. A communication system can support remote treatment providing clinical treatment at a distant place. This helps to reduce a barrier for the distance and can improve access to medical services which are not continuously used at remote farming areas. Furthermore, this is used to save life in important treatment and an emergency condition. A radio sensor network based on mobile communication can provide remote monitoring and sensors for parameters, such as the heart rate and blood pressure.

Radio and mobile communication becomes increasingly important in the industry application field. Wiring requires a high installation and maintenance cost. Accordingly, the possibility that a cable will be replaced with reconfigurable radio links is an attractive opportunity in many industrial fields. However, to achieve the possibility requires that a radio connection operates with latency, reliability and capacity similar to those of the cable and that management is simplified. Low latency and a low error probability is a new requirement for a connection to 5G.

Logistics and freight tracking is an important use case for mobile communication, which enables the tracking inventory and packages anywhere using a location-based information system. The logistics and freight tracking use case typically requires a low data speed, but a wide area and reliable location information.

The present disclosure described below can be implemented by combining or modifying respective embodiments to meet the above-described requirements of 5G.

The following describes in detail technical fields to which the present disclosure described below is applicable.

<Artificial Intelligence (AI)>

Artificial intelligence means the field in which artificial intelligence or methodology capable of producing artificial intelligence is researched. Machine learning means the field in which various problems handled in the artificial intelligence field are defined and methodology for solving the problems are researched. Machine learning is also defined as an algorithm for improving performance of a task through continuous experiences for the task.

An artificial neural network (ANN) is a model used in machine learning, and is configured with artificial neurons (nodes) forming a network through a combination of synapses, and may mean the entire model having a problem-solving ability. The artificial neural network may be defined by a connection pattern between the neurons of different layers, a learning process of updating a model parameter, and an activation function for generating an output value.

The artificial neural network may include an input layer, an output layer, and optionally one or more hidden layers. Each layer includes one or more neurons. The artificial neural network may include a synapse connecting neurons. In the artificial neural network, each neuron may output a function value of an activation function for input signals, weight, and a bias input through a synapse.

A model parameter means a parameter determined through learning, and includes the weight of a synapse connection and the bias of a neuron. Furthermore, a hyper parameter means a parameter that needs to be configured prior to learning in the machine learning algorithm, and includes a learning rate, the number of times of repetitions, a mini-deployment size, and an initialization function.

An object of learning of the artificial neural network may be considered to determine a model parameter that minimizes a loss function. The loss function may be used as an index for determining an optimal model parameter in the learning process of an artificial neural network.

Machine learning may be classified into supervised learning, unsupervised learning, and reinforcement learning based on a learning method.

Supervised learning means a method of training an artificial neural network in the state in which a label for learning data has been given. The label may mean an answer (or a result value) that must be deduced by an artificial neural network when learning data is input to the artificial neural network. Unsupervised learning may mean a method of training an artificial neural network in the state in which a label for learning data has not been given. Reinforcement learning may mean a learning method in which an agent defined within an environment is trained to select a behavior or behavior sequence that maximizes accumulated compensation in each state.

Machine learning implemented as a deep neural network (DNN) including a plurality of hidden layers, among artificial neural networks, is also called deep learning. Deep learning is part of machine learning. Hereinafter, machine learning is used as a meaning including deep learning.

<Robot>

A robot may mean a machine that automatically processes a given task or operates based on an autonomously owned ability. Particularly, a robot having a function for recognizing an environment and autonomously determining and performing an operation may be called an intelligence type robot.

A robot may be classified for industry, medical treatment, home, and military based on its use purpose or field.

A robot includes a driving unit including an actuator or motor, and may perform various physical operations, such as moving a robot joint. Furthermore, a movable robot includes a wheel, a brake, a propeller, etc. in a driving unit, and may run on the ground or fly in the air through the driving unit.

<Self-Driving (Autonomous-Driving)>

Self-driving means a technology for autonomous driving. A self-driving vehicle means a vehicle that runs without a user manipulation or by a user's minimum manipulation.

For example, self-driving may include all of a technology for maintaining a driving lane, a technology for automatically controlling speed, such as adaptive cruise control, a technology for automatic driving along a predetermined path, a technology for automatically configuring a path when a destination is set and driving.

A vehicle includes all of a vehicle having only an internal combustion engine, a hybrid vehicle including both an internal combustion engine and an electric motor, and an electric vehicle having only an electric motor, and may include a train, a motorcycle, etc. in addition to the vehicles.

In this case, the self-driving vehicle may be considered to be a robot having a self-driving function.

<Extended Reality (XR)>

Extended reality collectively refers to virtual reality (VR), augmented reality (AR), and mixed reality (MR). The VR technology provides an object or background of the real world as a CG image only. The AR technology provides a virtually produced CG image on an actual thing image. The MR technology is a computer graphics technology for mixing and combining virtual objects with the real world and providing them.

The MR technology is similar to the AR technology in that it shows a real object and a virtual object. However, in the AR technology, a virtual object is used in a form to supplement a real object. In contrast, unlike in the AR technology, in the MR technology, a virtual object and a real object are used as the same character.

The XR technology may be applied to a head-mount display (HMD), a head-up display (HUD), a mobile phone, a tablet PC, a laptop, a desktop, TV, and a digital signage. A device to which the XR technology has been applied may be called an XR device.

FIG. 1 illustrates an AI device 100 according to an embodiment of the present disclosure.

The AI device 100 may be implemented as a fixed device or mobile device, such as TV, a projector, a mobile phone, a smartphone, a desktop computer, a notebook, a terminal for digital broadcasting, a personal digital assistants (PDA), a portable multimedia player (PMP), a navigator, a tablet PC, a wearable device, a set-top box (STB), a DMB receiver, a radio, a washing machine, a refrigerator, a desktop computer, a digital signage, a robot, and a vehicle.

Referring to FIG. 1, the terminal 100 may include a communication unit 110, an input unit 120, a learning processor 130, a sensing unit 140, an output unit 150, a memory 170 and a processor 180.

The communication unit 110 may transmit and receive data to and from external devices, such as other AI devices 100a to 100er or an AI server 200, using wired and wireless communication technologies. For example, the communication unit 110 may transmit and receive sensor information, a user input, a learning model, and a control signal to and from external devices.

In this case, communication technologies used by the communication unit 110 include a global system for mobile communication (GSM), code division multi access (CDMA), long term evolution (LTE), 5G, a wireless LAN (WLAN), wireless-fidelity (Wi-Fi), Bluetooth™ radio frequency identification (RFID), infrared data association (IrDA), ZigBee, near field communication (NFC), etc.

The input unit 120 may obtain various types of data.

In this case, the input unit 120 may include a camera for an image signal input, a microphone for receiving an audio signal, a user input unit for receiving information from a user, etc. In this case, the camera or the microphone is treated as a sensor, and a signal obtained from the camera or the microphone may be called sensing data or sensor information.

The input unit 120 may obtain learning data for model learning and input data to be used when an output is obtained using a learning model. The input unit 120 may obtain not-processed input data. In this case, the processor 180 or the learning processor 130 may extract an input feature by performing pre-processing on the input data.

The learning processor 130 may be trained by a model configured with an artificial neural network using learning data. In this case, the trained artificial neural network may be called a learning model. The learning model is used to deduce a result value of new input data not learning data. The deduced value may be used as a base for performing a given operation.

In this case, the learning processor 130 may perform AI processing along with the learning processor 240 of the AI server 200.

In this case, the learning processor 130 may include memory integrated or implemented in the AI device 100. Alternatively, the learning processor 130 may be implemented using the memory 170, external memory directly coupled to the AI device 100 or memory maintained in an external device.

The sensing unit 140 may obtain at least one of internal information of the AI device 100, surrounding environment information of the AI device 100, or user information using various sensors.

In this case, sensors included in the sensing unit 140 include a proximity sensor, an illumination sensor, an acceleration sensor, a magnetic sensor, a gyro sensor, an inertia sensor, an RGB sensor, an IR sensor, a fingerprint recognition sensor, an ultrasonic sensor, a photo sensor, a microphone, LIDAR, and a radar.

The output unit 150 may generate an output related to a visual sense, an auditory sense or a tactile sense.

In this case, the output unit 150 may include a display unit for outputting visual information, a speaker for outputting auditory information, and a haptic module for outputting tactile information.

The memory 170 may store data supporting various functions of the AI device 100. For example, the memory 170 may store input data obtained by the input unit 120, learning data, a learning model, a learning history, etc.

The processor 180 may determine at least one executable operation of the AI device 100 based on information, determined or generated using a data analysis algorithm or a machine learning algorithm. Furthermore, the processor 180 may perform the determined operation by controlling elements of the AI device 100.

To this end, the processor 180 may request, search, receive, and use the data of the learning processor 130 or the memory 170, and may control elements of the AI device 100 to execute a predicted operation or an operation determined to be preferred, among the at least one executable operation.

In this case, if association with an external device is necessary to perform the determined operation, the processor 180 may generate a control signal for controlling the corresponding external device and transmit the generated control signal to the corresponding external device.

The processor 180 may obtain intention information for a user input and transmit user requirements based on the obtained intention information.

In this case, the processor 180 may obtain the intention information, corresponding to the user input, using at least one of a speech to text (STT) engine for converting a voice input into a text string or a natural language processing (NLP) engine for obtaining intention information of a natural language.

In this case, at least some of at least one of the STT engine or the NLP engine may be configured as an artificial neural network trained based on a machine learning algorithm. Furthermore, at least one of the STT engine or the NLP engine may have been trained by the learning processor 130, may have been trained by the learning processor 240 of the AI server 200 or may have been trained by distributed processing thereof.

The processor 180 may collect history information including the operation contents of the AI device 100 or the feedback of a user for an operation, may store the history information in the memory 170 or the learning processor 130, or may transmit the history information to an external device, such as the AI server 200. The collected history information may be used to update a learning model.

The processor 18 may control at least some of the elements of the AI device 100 in order to execute an application program stored in the memory 170. Moreover, the processor 180 may combine and drive two or more of the elements included in the AI device 100 in order to execute the application program.

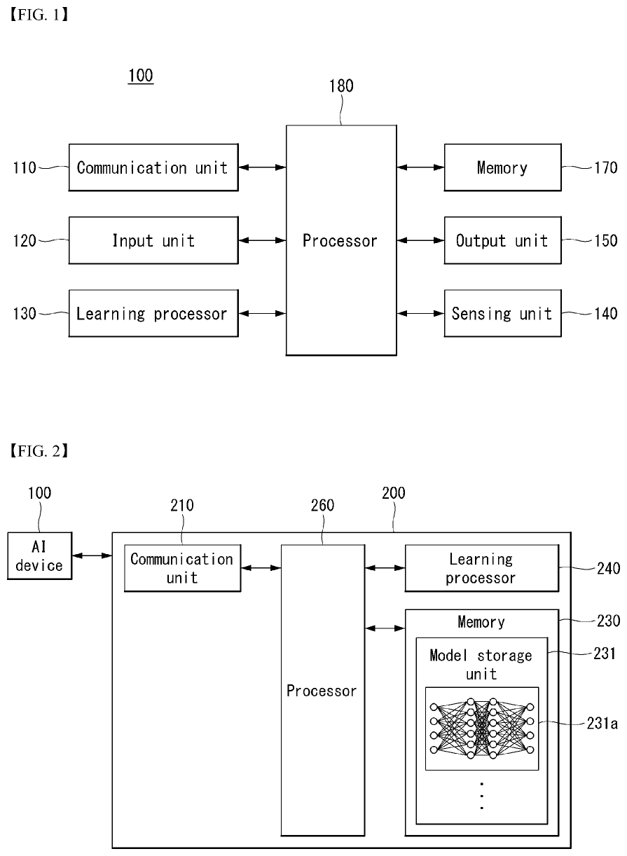

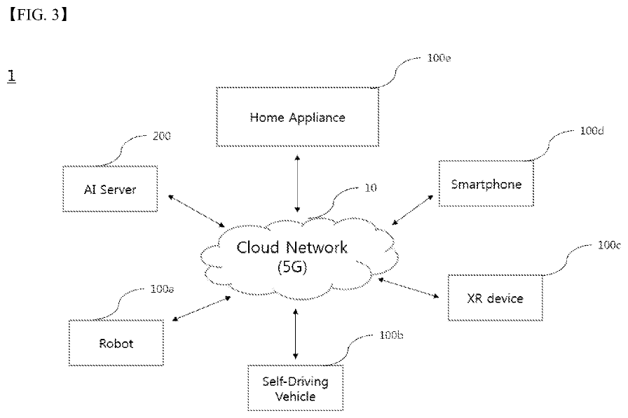

FIG. 2 illustrates an AI server 200 according to an embodiment of the present disclosure.

Referring to FIG. 2, the AI server 200 may mean a device which is trained by an artificial neural network using a machine learning algorithm or which uses a trained artificial neural network. In this case, the AI server 200 is configured with a plurality of servers and may perform distributed processing and may be defined as a 5G network. In this case, the AI server 200 may be included as a partial configuration of the AI device 100, and may perform at least some of AI processing.

The AI server 200 may include a communication unit 210, a memory 230, a learning processor 240 and a processor 260.

The communication unit 210 may transmit and receive data to and from an external device, such as the AI device 100.

The memory 230 may include a model storage unit 231. The model storage unit 231 may store a model (or artificial neural network 231a) which is being trained or has been trained through the learning processor 240.

The learning processor 240 may train the artificial neural network 231a using learning data. The learning model may be used in the state in which it has been mounted on the AI server 200 of the artificial neural network or may be mounted on an external device, such as the AI device 100, and used.

The learning model may be implemented as hardware, software or a combination of hardware and software. If some of or the entire learning model is implemented as software, one or more instructions configuring the learning model may be stored in the memory 230.

The processor 260 may deduce a result value of new input data using the learning model, and may generate a response or control command based on the deduced result value.

FIG. 3 illustrates an AI system 1 according to an embodiment of the present disclosure.

Referring to FIG. 3, the AI system 1 is connected to at least one of the AI server 200, a robot 100a, a self-driving vehicle 100b, an XR device 100c, a smartphone 100d or home appliances 100e over a cloud network 10. In this case, the robot 100a, the self-driving vehicle 100b, the XR device 100c, the smartphone 100d or the home appliances 100e to which the AI technology has been applied may be called AI devices 100a to 100e.

The cloud network 10 may configure part of cloud computing infra or may mean a network present within cloud computing infra. In this case, the cloud network 10 may be configured using the 3G network, the 4G or long term evolution (LTE) network or the 5G network.

That is, the devices 100a to 100e (200) configuring the AI system 1 may be interconnected over the cloud network 10. Particularly, the devices 100a to 100e and 200 may communicate with each other through a base station, but may directly communicate with each other without the intervention of a base station.

The AI server 200 may include a server for performing AI processing and a server for performing calculation on big data.

The AI server 200 is connected to at least one of the robot 100a, the self-driving vehicle 100b, the XR device 100c, the smartphone 100d or the home appliances 100e, that is, AI devices configuring the AI system 1, over the cloud network 10, and may help at least some of the AI processing of the connected AI devices 100a to 100e.

In this case, the AI server 200 may train an artificial neural network based on a machine learning algorithm in place of the AI devices 100a to 100e, may directly store a learning model or may transmit the learning model to the AI devices 100a to 100e.

In this case, the AI server 200 may receive input data from the AI devices 100a to 100e, may deduce a result value of the received input data using the learning model, may generate a response or control command based on the deduced result value, and may transmit the response or control command to the AI devices 100a to 100e.

Alternatively, the AI devices 100a to 100e may directly deduce a result value of input data using a learning model, and may generate a response or control command based on the deduced result value.

Hereinafter, various embodiments of the AI devices 100a to 100e to which the above-described technology is applied are described. In this case, the AI devices 100a to 100e shown in FIG. 3 may be considered to be detailed embodiments of the AI device 100 shown in FIG. 1.

<AI+Robot>

An AI technology is applied to the robot 100a, and the robot 100a may be implemented as a guidance robot, a transport robot, a cleaning robot, a wearable robot, an entertainment robot, a pet robot, an unmanned flight robot, etc.

The robot 100a may include a robot control module for controlling an operation. The robot control module may mean a software module or a chip in which a software module has been implemented using hardware.

The robot 100a may obtain state information of the robot 100a, may detect (recognize) a surrounding environment and object, may generate map data, may determine a moving path and a running plan, may determine a response to a user interaction, or may determine an operation using sensor information obtained from various types of sensors.

In this case, the robot 100a may use sensor information obtained by at least one sensor among LIDAR, a radar, and a camera in order to determine the moving path and running plan.

The robot 100a may perform the above operations using a learning model configured with at least one artificial neural network. For example, the robot 100a may recognize a surrounding environment and object using a learning model, and may determine an operation using recognized surrounding environment information or object information. In this case, the learning model may have been directly trained in the robot 100a or may have been trained in an external device, such as the AI server 200.

In this case, the robot 100a may directly generate results using the learning model and perform an operation, but may perform an operation by transmitting sensor information to an external device, such as the AI server 200, and receiving results generated in response thereto.

The robot 100a may determine a moving path and running plan using at least one of map data, object information detected from sensor information, or object information obtained from an external device. The robot 100a may run along the determined moving path and running plan by controlling the driving unit.

The map data may include object identification information for various objects disposed in the space in which the robot 100a moves. For example, the map data may include object identification information for fixed objects, such as a wall and a door, and movable objects, such as a flowport and a desk. Furthermore, the object identification information may include a name, a type, a distance, a location, etc.

Furthermore, the robot 100a may perform an operation or run by controlling the driving unit based on a user's control/interaction. In this case, the robot 100a may obtain intention information of an interaction according to a user's behavior or voice speaking, may determine a response based on the obtained intention information, and may perform an operation.

<AI+Self-Driving>

An AI technology is applied to the self-driving vehicle 100b, and the self-driving vehicle 100b may be implemented as a movable type robot, a vehicle, an unmanned flight body, etc.

The self-driving vehicle 100b may include a self-driving control module for controlling a self-driving function. The self-driving control module may mean a software module or a chip in which a software module has been implemented using hardware. The self-driving control module may be included in the self-driving vehicle 100b as an element of the self-driving vehicle 100b, but may be configured as separate hardware outside the self-driving vehicle 100b and connected to the self-driving vehicle 100b.

The self-driving vehicle 100b may obtain state information of the self-driving vehicle 100b, may detect (recognize) a surrounding environment and object, may generate map data, may determine a moving path and running plan, or may determine an operation using sensor information obtained from various types of sensors.

In this case, in order to determine the moving path and running plan, like the robot 100a, the self-driving vehicle 100b may use sensor information obtained from at least one sensor among LIDAR, a radar and a camera.

Particularly, the self-driving vehicle 100b may recognize an environment or object in an area whose view is blocked or an area of a given distance or more by receiving sensor information for the environment or object from external devices, or may directly receive recognized information for the environment or object from external devices.

The self-driving vehicle 100b may perform the above operations using a learning model configured with at least one artificial neural network. For example, the self-driving vehicle 100b may recognize a surrounding environment and object using a learning model, and may determine the flow of running using recognized surrounding environment information or object information. In this case, the learning model may have been directly trained in the self-driving vehicle 100b or may have been trained in an external device, such as the AI server 200.

In this case, the self-driving vehicle 100b may directly generate results using the learning model and perform an operation, but may perform an operation by transmitting sensor information to an external device, such as the AI server 200, and receiving results generated in response thereto.

The self-driving vehicle 100b may determine a moving path and running plan using at least one of map data, object information detected from sensor information or object information obtained from an external device. The self-driving vehicle 100b may run based on the determined moving path and running plan by controlling the driving unit.

The map data may include object identification information for various objects disposed in the space (e.g., road) in which the self-driving vehicle 100b runs. For example, the map data may include object identification information for fixed objects, such as a streetlight, a rock, and a building, etc., and movable objects, such as a vehicle and a pedestrian. Furthermore, the object identification information may include a name, a type, a distance, a location, etc.

Furthermore, the self-driving vehicle 100b may perform an operation or may run by controlling the driving unit based on a user's control/interaction. In this case, the self-driving vehicle 100b may obtain intention information of an interaction according to a user′ behavior or voice speaking, may determine a response based on the obtained intention information, and may perform an operation.

<AI+XR>

An AI technology is applied to the XR device 100c, and the XR device 100c may be implemented as a head-mount display, a head-up display provided in a vehicle, television, a mobile phone, a smartphone, a computer, a wearable device, home appliances, a digital signage, a vehicle, a fixed type robot or a movable type robot.

The XR device 100c may generate location data and attributes data for three-dimensional points by analyzing three-dimensional point cloud data or image data obtained through various sensors or from an external device, may obtain information on a surrounding space or real object based on the generated location data and attributes data, and may output an XR object by rendering the XR object. For example, the XR device 100c may output an XR object, including additional information for a recognized object, by making the XR object correspond to the corresponding recognized object.

The XR device 100c may perform the above operations using a learning model configured with at least one artificial neural network. For example, the XR device 100c may recognize a real object in three-dimensional point cloud data or image data using a learning model, and may provide information corresponding to the recognized real object. In this case, the learning model may have been directly trained in the XR device 100c or may have been trained in an external device, such as the AI server 200.

In this case, the XR device 100c may directly generate results using a learning model and perform an operation, but may perform an operation by transmitting sensor information to an external device, such as the AI server 200, and receiving results generated in response thereto.

<AI+Robot+Self-Driving>

An AI technology and a self-driving technology are applied to the robot 100a, and the robot 100a may be implemented as a guidance robot, a transport robot, a cleaning robot, a wearable robot, an entertainment robot, a pet robot, an unmanned flight robot, etc.

The robot 100a to which the AI technology and the self-driving technology have been applied may mean a robot itself having a self-driving function or may mean the robot 100a interacting with the self-driving vehicle 100b.

The robot 100a having the self-driving function may collectively refer to devices that autonomously move along a given flow without control of a user or autonomously determine a flow and move.

The robot 100a and the self-driving vehicle 100b having the self-driving function may use a common sensing method in order to determine one or more of a moving path or a running plan. For example, the robot 100a and the self-driving vehicle 100b having the self-driving function may determine one or more of a moving path or a running plan using information sensed through LIDAR, a radar, a camera, etc.

The robot 100a interacting with the self-driving vehicle 100b is present separately from the self-driving vehicle 100b, and may perform an operation associated with a self-driving function inside or outside the self-driving vehicle 100b or associated with a user got in the self-driving vehicle 100b.

In this case, the robot 100a interacting with the self-driving vehicle 100b may control or assist the self-driving function of the self-driving vehicle 100b by obtaining sensor information in place of the self-driving vehicle 100b and providing the sensor information to the self-driving vehicle 100b, or by obtaining sensor information, generating surrounding environment information or object information, and providing the surrounding environment information or object information to the self-driving vehicle 100b.

Alternatively, the robot 100a interacting with the self-driving vehicle 100b may control the function of the self-driving vehicle 100b by monitoring a user got in the self-driving vehicle 100b or through an interaction with a user. For example, if a driver is determined to be a drowsiness state, the robot 100a may activate the self-driving function of the self-driving vehicle 100b or assist control of the driving unit of the self-driving vehicle 100b. In this case, the function of the self-driving vehicle 100b controlled by the robot 100a may include a function provided by a navigation system or audio system provided within the self-driving vehicle 100b, in addition to a self-driving function simply.

Alternatively, the robot 100a interacting with the self-driving vehicle 100b may provide information to the self-driving vehicle 100b or may assist a function outside the self-driving vehicle 100b. For example, the robot 100a may provide the self-driving vehicle 100b with traffic information, including signal information, as in a smart traffic light, and may automatically connect an electric charger to a filling inlet through an interaction with the self-driving vehicle 100b as in the automatic electric charger of an electric vehicle.

<AI+Robot+XR>

An AI technology and an XR technology are applied to the robot 100a, and the robot 100a may be implemented as a guidance robot, a transport robot, a cleaning robot, a wearable robot, an entertainment robot, a pet robot, an unmanned flight robot, a drone, etc.

The robot 100a to which the XR technology has been applied may mean a robot, that is, a target of control/interaction within an XR image. In this case, the robot 100a is different from the XR device 100c, and they may operate in conjunction with each other.

When the robot 100a, that is, a target of control/interaction within an XR image, obtains sensor information from sensors including a camera, the robot 100a or the XR device 100c may generate an XR image based on the sensor information, and the XR device 100c may output the generated XR image. Furthermore, the robot 100a may operate based on a control signal received through the XR device 100c or a user's interaction.

For example, a user may identify a corresponding XR image at timing of the robot 100a, remotely operating in conjunction through an external device, such as the XR device 100c, may adjust the self-driving path of the robot 100a through an interaction, may control an operation or driving, or may identify information of a surrounding object.

<AI+Self-Driving+XR>

An AI technology and an XR technology are applied to the self-driving vehicle 100b, and the self-driving vehicle 100b may be implemented as a movable type robot, a vehicle, an unmanned flight body, etc.

The self-driving vehicle 100b to which the XR technology has been applied may mean a self-driving vehicle equipped with means for providing an XR image or a self-driving vehicle, that is, a target of control/interaction within an XR image. Particularly, the self-driving vehicle 100b, that is, a target of control/interaction within an XR image, is different from the XR device 100c, and they may operate in conjunction with each other.

The self-driving vehicle 100b equipped with the means for providing an XR image may obtain sensor information from sensors including a camera, and may output an XR image generated based on the obtained sensor information. For example, the self-driving vehicle 100b includes an HUD, and may provide a passenger with an XR object corresponding to a real object or an object within a screen by outputting an XR image.

In this case, when the XR object is output to the HUD, at least some of the XR object may be output with it overlapping a real object toward which a passenger's view is directed. In contrast, when the XR object is displayed on a display included within the self-driving vehicle 100b, at least some of the XR object may be output so that it overlaps an object within a screen. For example, the self-driving vehicle 100b may output XR objects corresponding to objects, such as a carriageway, another vehicle, a traffic light, a signpost, a two-wheeled vehicle, a pedestrian, and a building.

When the self-driving vehicle 100b, that is, a target of control/interaction within an XR image, obtains sensor information from sensors including a camera, the self-driving vehicle 100b or the XR device 100c may generate an XR image based on the sensor information. The XR device 100c may output the generated XR image. Furthermore, the self-driving vehicle 100b may operate based on a control signal received through an external device, such as the XR device 100c, or a user's interaction.

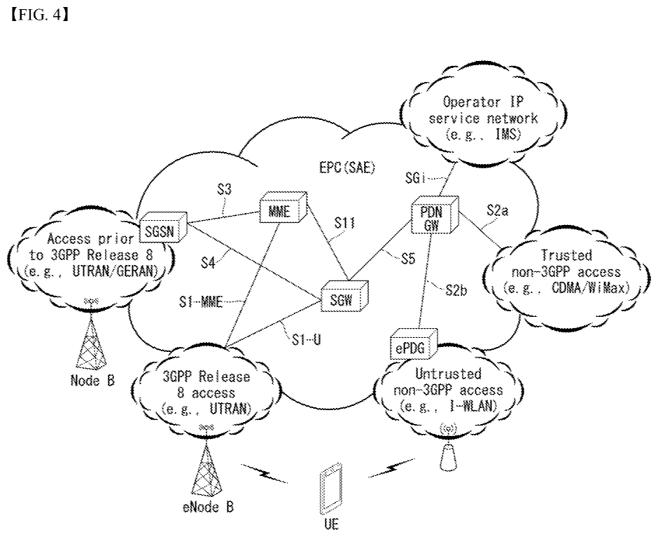

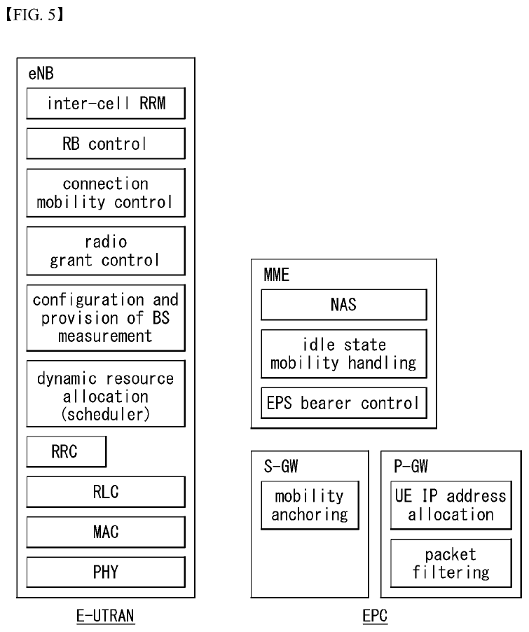

First, terms used in the present disclosure are defined as follows.
IP Multimedia Subsystem or IP Multimedia Core Network Subsystem (IMS): An architectural framework for providing standardization for delivering voice or other multimedia services over IP.
Universal Mobile Telecommunications System (UMTS): A 3rd generation mobile communication technology based on a Global System for Mobile Communication (GSM), developed by 3GPP.
Evolved Packet System (EPS): A network system consisting of an Evolved Packet Core (EPC), which is an Internet Protocol (IP)-based packet switched (PS) core network, and an access network such as LTE/UTRAN. The EPS is a network evolved from the UMTS.
NodeB: a base station of GERAN/UTRAN. It is installed outdoors and its coverage is a macro cell scale.
eNodeB/eNB: a base station of E-UTRAN. It is installed outdoors and its coverage is a macro cell scale.
User Equipment (UE): A user device. The UE may be referred to in terms of UE (terminal), Mobile Equipment (ME), Mobile Station (MS), and the like. In addition, the UE may be a portable device such as a notebook computer, a mobile phone, a personal digital assistant (PDA), a smart phone, or a multimedia device, or may be a non-portable device such as a personal computer (PC) or a vehicle-mounted device. The term UE or terminal may refer to an MTC device in the description related to MTC.
Home NodeB (HNB): As a base station of the UMTS network, it is installed indoors and its coverage is a micro cell scale.
Home eNodeB (HeNB): As a base station of the EPS network, it is installed indoors and its coverage is a micro cell scale.
Mobility Management Entity (MME): A network node of the EPS network that performs functions such as mobility management (MM) and session management (SM).
Packet Data Network-Gateway (PDN-GW)/PGW/P-GW: A network node of the EPS network that performs functions such as UE IP address allocation, packet screening and filtering, and charging data collection.
Serving Gateway (SGW)/S-GW: A network node of the EPS network that performs functions such as a mobility anchor, packet routing, idle mode packet buffering, and triggering the MME to page the UE.
Policy and Charging Rule Function (PCRF): A network node of the EPS network that performs policy decisions to dynamically apply differentiated QoS and charging policies for each service flow.
Open Mobile Alliance Device Management (OMA DM): A protocol designed to manage mobile devices such as cell phones, PDAs, and portable computers, which performs functions such as device configuration, firmware upgrade, and error report.
Operation Administration and Maintenance (OAM): A group of network management functions that provide network fault indication, performance information, and data and diagnostic functions.
Non-Access Stratum (NAS): An upper stratum of a control plane between the UE and the MME. As a functional layer for sending and receiving signaling and traffic messages between the UE and the core network in the LTE/UMTS protocol stack, it supports the mobility of the UE, and supports session management procedures and IP address management for establishing and maintaining an IP connection between the UE and PDN GW.
EPS Mobility Management (EMM): As a sub-layer of the NAS layer, the EMM may be in the “EMM-Registered” or “EMM-Deregistered” state depending on whether the UE is attached to the network or detached from the network.
EMM Connection Management (ECM) connection: A signaling connection for the exchange of NAS messages established between the UE and the MME. An ECM connection is a logical connection consisting of an RRC connection between the UE and the eNB and an S1 signaling connection between the eNB and the MME. When the ECM connection is established/terminated, the RRC and S1 signaling connection are similarly established/terminated. The established ECM connection means to have the RRC connection established with the eNB to the UE, and means to have an established S1 signaling connection with the eNB to the MME. The ECM may have a state of “ECM-Connected” or “ECM-Idle” depending on whether the NAS signaling connection, that is, the ECM connection is established.
Access-Stratum (AS): It includes a protocol stack between the UE and a wireless (or access) network, and is responsible for transmitting data and network control signals.
NAS configuration Management Object (MO): A Management Object (MO) used in a process of configuring parameters related to NAS functionality to the UE.
Packet Data Network (PDN): A network in which a server (for example, a multimedia messaging service (MMS) server, a wireless application protocol (WAP) server, etc.) supporting a specific service is located.
PDN connection: A logical connection between the UE and the PDN, represented by one IP address (one IPv4 address and/or one IPv6 prefix).
Access Point Name (APN): A string that refers to or identifies the PDN. In order to access the requested service or network, a specific P-GW is passed, which means a name (string) defined in advance in the network so that this P-GW can be found. (for example, internet.mnc012.mcc345.gprs)
Radio Access Network (RAN): A unit including a NodeB, an eNodeB, and a Radio Network Controller (RNC) controlling them in a 3GPP network. It exists between UEs and provides connection to the core network.
Home Location Register (HLR)/Home Subscriber Server (HSS): A database containing subscriber information in 3GPP network. The HSS may perform functions such as configuration storage, identity management, and user state storage.
Public Land Mobile Network (PLMN): A network constructed for the purpose of providing mobile communication services to individuals. It may be formed separately for each operator.
Access Network Discovery and Selection Function (ANDSF): It provides a policy that allows the UE to discover and select available access on a per operator basis as a single network entity.
EPC path (or infrastructure data path): A user plane communication path through EPC
E-UTRAN Radio Access Bearer (E-RAB): It refers to the concatenation of the S1 bearer and the data radio bearer. If there is an E-RAB, there is a one-to-one mapping between the E-RAB and an EPS bearer of the NAS.
GPRS Tunneling Protocol (GTP): A group of IP-based communications protocols used to carry general packet radio service (GPRS) within GSM, UMTS and LTE networks. Within 3GPP architecture, GTP and proxy mobile IPv6-based interfaces are specified on various interface points. The GTP may be decomposed into several protocols (e.g. GTP-C, GTP-U and GTP′). The GTP-C is used within a GPRS core network for signaling between gateway GPRS support nodes (GGSN) and serving GPRS support nodes (SGSN). The GTP-C allows activating a session by the SGSN for a user (e.g., PDN context activation), deactivating the same session, adjusting the quality of service parameters, or updating a session for a subscriber who has just operated from another SGSN. The GTP-U is used to carry user data within the GPRS core network and between radio access networks and core networks. FIG. 4 is a diagram illustrating a schematic structure of an Evolved Packet System (EPS) including an Evolved Packet Core (EPC).
Cell as radio resource: A 3GPP LTE/LTE-A system uses a concept of a cell to manage radio resources, and a cell related with the radio resources is distinguished from a cell in a geographic area. The term “cell” related with the radio resources is defined as a combination of downlink (DL) resources and uplink (UL) resources, that is, a combination of a DL carrier and a UL carrier. The cell may be configured with the DL resources alone or a combination of the DL resources and the UL resources. When carrier aggregation is supported, a linkage between a carrier frequency of the DL resources and a carrier frequency of the UL resources may be indicated by system information. Here, the carrier frequency means a center frequency of each cell or carrier. In particular, a cell operating on a primary frequency is referred to as a primary cell (Pcell), and a cell operating on a secondary frequency is referred to as a secondary cell (Scell). The Scell refers to a cell that can be configured after Radio Resource Control (RRC) connection establishment is made and can be used to provide additional radio resources. Depending on the capabilities of the UE, the Scell may form a set of serving cells for the UE together with the Pcell. In the case of a UE that is in the RRC_CONNECTED state, but carrier aggregation is not configured, or does not support carrier aggregation, there is only one serving cell configured as only the Pcell. Meanwhile, the “cell” in the geographic area may be understood as a coverage in which a node can provide a service using the carrier, and the “cell” of the radio resources is related with a bandwidth (BW), which is a frequency range configured by the carrier. Since downlink coverage, which is a range in which the node can transmit valid signals, and uplink coverage, which is a range in which valid signals can be received from the UE, depend on the carrier that carries the corresponding signal, the coverage of the node is also related to the coverage of the “cell” of the radio resources used by the node. Thus, the term “cell” may sometimes be used to mean the coverage of the service by the node, sometimes be used to mean radio resources, and sometimes be used to mean a range within which the signal using the radio resources can reach an effective strength.

The EPC is a main component of the System Architecture Evolution (SAE) intended for improving performance of the 3GPP technologies. SAE is a research project for determining a network structure supporting mobility between multiple heterogeneous networks. For example, SAE is intended to provide an optimized packet-based system which supports various IP-based wireless access technologies, provides much more improved data transmission capability, and so on.

More specifically, the EPC is the core network of an IP-based mobile communication system for the 3GPP LTE system and capable of supporting packet-based real-time and non-real time services. In the existing mobile communication systems (namely, in the 2nd or 3rd mobile communication system), functions of the core network have been implemented through two separate sub-domains: a Circuit-Switched (CS) sub-domain for voice and a Packet-Switched (PS) sub-domain for data. However, in the 3GPP LTE system, an evolution from the 3rd mobile communication system, the CS and PS sub-domains have been unified into a single IP domain. In other words, in the 3GPP LTE system, connection between UEs having IP capabilities may be established through an IP-based base station (for example, eNodeB), EPC, and application domain (for example, IMS). In other words, the EPC provides the architecture essential for implementing end-to-end IP services.

The EPC includes various components, where FIG. 1 illustrates part of the EPC components, including a Serving Gateway (SGW or S-GW), Packet Data Network Gateway (PDN GW or PGW or P-GW), Mobility Management Entity (MME), Serving GPRS Supporting Node (SGSN), and enhanced Packet Data Gateway (ePDG).

The SGW operates as a boundary point between the Radio Access Network (RAN) and the core network and maintains a data path between the eNodeB and the PDN GW. Also, if UE moves across serving areas by the eNodeB, the SGW acts as an anchor point for local mobility. In other words, packets may be routed through the SGW to ensure mobility within the E-UTRAN (Evolved-UMTS (Universal Mobile Telecommunications System) Terrestrial Radio Access Network defined for the subsequent versions of the 3GPP release 8). Also, the SGW may act as an anchor point for mobility between the E-UTRAN and other 3GPP networks (the RAN defined before the 3GPP release 8, for example, UTRAN or GERAN (GSM (Global System for Mobile Communication)/EDGE (Enhanced Data rates for Global Evolution) Radio Access Network).

The PDN GW corresponds to a termination point of a data interface to a packet data network. The PDN GW may support policy enforcement features, packet filtering, charging support, and so on. Also, the PDN GW may act as an anchor point for mobility management between the 3GPP network and non-3GPP networks (for example, an unreliable network such as the Interworking Wireless Local Area Network (I-WLAN) or reliable networks such as the Code Division Multiple Access (CDMA) network and WiMax).

The example of the network structure of FIG. 1 shows that the SGW and the PDN GW are configured as separate gateways, but two gateways may be implemented according to a single gateway configuration option.

The MME performs signaling for the UE's access to the network, supporting allocation, tracking, paging, roaming, handover of network resources, and so on; and control functions. The MME controls control plane functions related to subscribers and session management. The MME manages a plurality of eNodeBs and performs signaling of the conventional gateway's selection for handover to other 2G/3G networks. Also, the MME performs such functions as security procedures, terminal-to-network session handling, idle terminal location management, and so on.

The SGSN deals with all kinds of packet data including the packet data for mobility management and authentication of the user with respect to other 3GPP networks (for example, the GPRS network).

The ePDG acts as a security node with respect to an unreliable, non-3GPP network (for example, I-WLAN, WiFi hotspot, and so on).

As described with reference to FIG. 4, the UE having IP capability may access an IP service network (e.g. IMS) provided by a businessman (i.e. operator) via various elements within the EPC based on non-3GPP access as well as 3GPP access.

In addition, FIG. 4 illustrates various reference points (e.g. S1-U, S1-MME, etc.). In the 3GPP system, a conceptual link connecting two functions existing in different functional entities of E-UTRAN and the EPC is defined as a reference point. Table 1 below summarizes the reference points shown in FIG. 4. In addition to the examples in Table 1, various reference points may exist according to the network structure.

TABLE 1

| Reference | |
|---|---|
| Point | Description |
| S1-MME | Reference point for the control plane protocol between E-UTRAN and |
| | MME |
| S 1-U | Reference point between E-UTRAN and Serving GW for the per bearer |
| | user plane tunneling and inter eNodeB path switching during handover |
| S3 | It enables user and bearer information exchange for inter 3GPP access |
| | network mobility in idle and/or active state. This reference point may be |
| | used intra-PLMN or inter-PLMN (e.g. in the case of Inter-PLMN HO). |
| S4 | It provides related control and mobility support between GPRS core and |
| | the 3GPP anchor function of Serving GW. In addition, if direct tunnel is |
| | not established, it provides the user plane tunneling. |
| S5 | It provides user plane tunneling and tunnel management between Serving |
| | GW and PDN GW. It is used for Serving GW relocation due to UE mobility |
| | if the Serving GW needs to connect to a non-collocated PDN GW for the |
| | required PDN connectivity. |
| S11 | Reference point for the control plane protocol between MME and SGW |
| SGi | It is the reference point between the PDN GW and the packet data network. |
| | Packet data network may be an operator external public or private packet |
| | data network or an intra-operator packet data network (e.g., for provision |
| | of IMS services). This reference point corresponds to Gi for 3GPP accesses. |

S2a and S2b correspond to non-3GPP interfaces among the reference points shown in FIG. 4. S2a is a reference point that provides related control and mobility support between trusted non-3GPP access and the PDN GW to the user plane. S2b is a reference point that provides related control and mobility support between the ePDG and the PDN GW to the user plane.

FIG. 5 is an exemplary diagram illustrating architecture of a general E-UTRAN and EPC.

As shown, the eNB may perform functions for routing to the gateway while the Radio Resource Control (RRC) connection is active, scheduling and transmitting of paging messages, scheduling and transmitting of broadcasting channel (BCH), dynamic allocation of resources in the uplink and downlink to the UE, configuration and provision for measurement of the eNB, radio bearer control, radio admission control, and connection mobility control. In the EPC, paging generation, LTE IDLE state management, ciphering of the user plane, SAE bearer control, ciphering of NAS signaling and integrity protection functions may be performed.

Annex J of 3GPP TR 23.799 shows various architecture combining 5G and 4G. In addition, architecture using NR and NGC are shown in 3GPP TS 23.501.

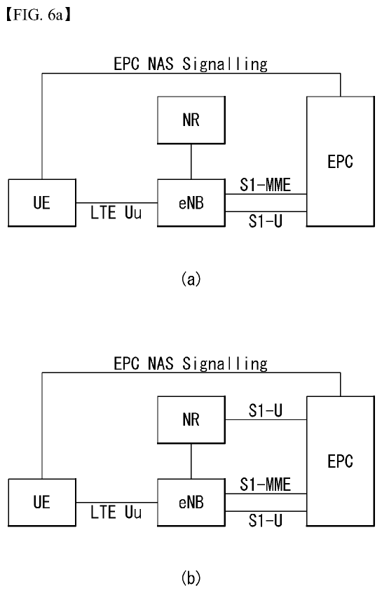

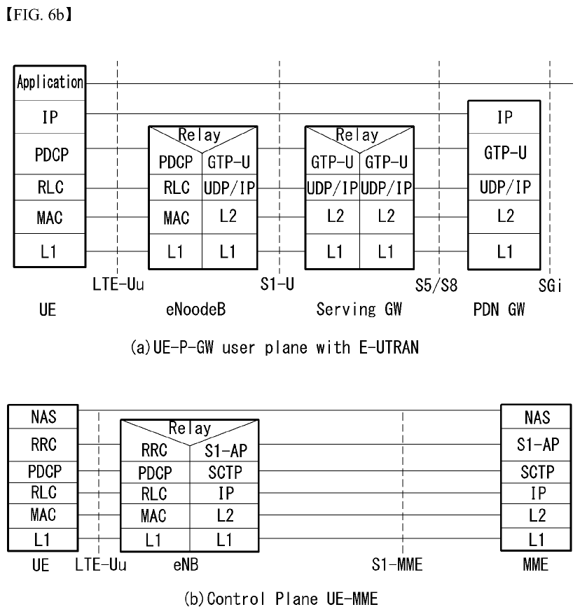

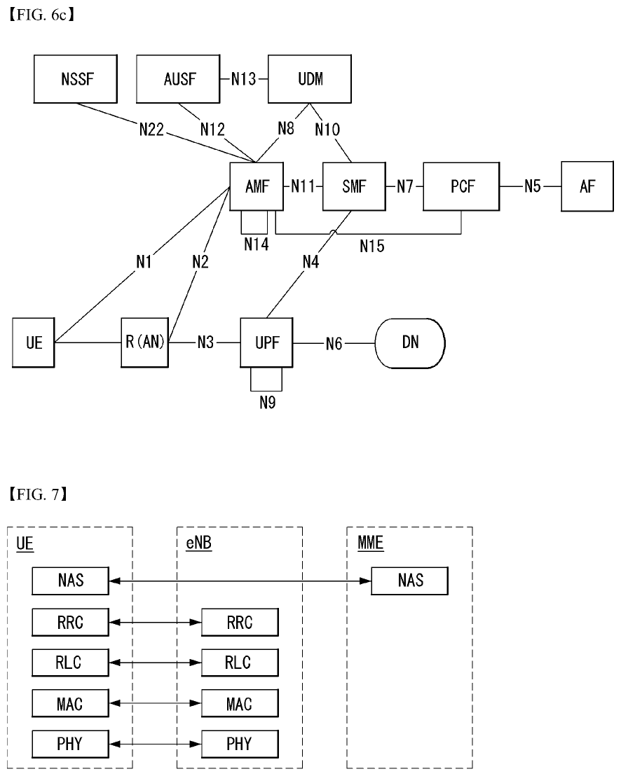

FIG. 6A is an example of a case in which NR, that is, only 5G radio access technology is additionally used in an existing EPS system.

In FIG. 6A, the eNB additionally manages radio resources using NR in addition to radio resource management using LTE. Therefore, such an eNB may provide various access opportunities by utilizing both LTE and NR. FIG. 6A (a) is a case where an NR cell is connected to a core network via an eNB, and FIG. 6A (b) is a case where an NR is directly connected to a core network.

FIG. 6B is an example of a case in which an LTE radio connection is additionally added in a situation in which NG RAN and NGC are utilized in the opposite situation of FIG. 6A.

In FIG. 6B, an NR node additionally manages radio resources using LTE using an eNB in addition to radio resource management using NR. Therefore, such an NR node may provide various access opportunities by utilizing both LTE and NR. FIG. 6B (a) shows a case where a traffic of the eNB is connected to a core network via the NR node, and FIG. 6B (b) shows a case where the traffic of the eNB is directly connected to the core network.

FIG. 6C shows an example of a typical 5G architecture. The following is a description of each reference interface and node in FIG. 6C.

An access and mobility management function (AMF) supports functions of inter-CN node signaling for mobility between 3GPP access networks, termination of radio access network (RAN) CP interface N2, termination N1 of NAS signaling, registration management (registration area management), idle mode UE reachability, support of network slicing, SMF selection, and the like.

Some or all of the functions of the AMF can be supported in a single instance of one AMF.

A data network (DN) means, for example, operator services, internet access, or 3rd party service, etc. The DN transmits a downlink protocol data unit (PDU) to the UPF or receives the PDU transmitted from the UE from the UPF.

A policy control function (PCF) receives information about packet flow from an application server and provides functions of determining policies such as mobility management and session management.

A session management function (SMF) provides a session management function. If the UE has a plurality of sessions, the sessions can be respectively managed by different SMFs.

Some or all of the functions of the SMF can be supported in a single instance of one SMF.

A unified data management (UDM) stores subscription data of user, policy data, etc.

A user plane function (UPF) transmits the downlink PDU received from the DN to the UE via the (R)AN and transmits the uplink PDU received from the UE to the DN via the (R)AN.

An application function (AF) interacts with 3GPP core network to provide services (e.g., to support functions of an application influence on traffic routing, network capability exposure access, interaction with policy framework for policy control, and the like).

A (radio) access network (R)AN collectively refers to a new radio access network supporting both evolved E-UTRA, that is an evolved version of 4G radio access technology, and a new radio (NR) access technology (e.g., gNB).

The gNB supports functions for radio resource management (i.e., radio bearer control, radio admission control, connection mobility control, and dynamic allocation of resources (i.e., scheduling) to the UE in uplink/downlink)

The UE means a user equipment.

In the 3GPP system, a conceptual link connecting between the NFs in the 5G system is defined as a reference point.

N1 is a reference point between the UE and the AMF, N2 is a reference point between the (R)AN and the AMF, N3 is a reference point between the (R)AN and the UPF, N4 is a reference point between the SMF and the UPF, N6 is a reference point between the UPF and the data network, N9 is a reference point between two core UPFs, N5 is a reference point between the PCF and the AF, N7 is a reference point between the SMF and the PCF, N24 is a reference point between the PCF in the visited network and the PCF in the home network, N8 is a reference point between the UDM and the AMF, N10 is a reference point between the UDM and the SMF, N11 is a reference point between the AMF and the SMF, N12 is a reference point between the AMF and an authentication server function (AUSF), N13 is a reference point between the UDM and the AUSF, N14 is a reference point between two AMFs, N15 is a reference point between the PCF and the AMF in case of non-roaming scenario, reference point between the PCF in the visited network and the AMF in case of roaming scenario, N16 is a reference point between two SMFs (reference point between the SMF in the visited network and the SMF in the home network in case of roaming scenario), N17 is a reference point between AMF and 5G-equipment identity register (EIR), N18 is a reference point between the AMF and an unstructured data storage function (UDSF), N22 is a reference point between the AMF and a network slice selection function (NSSF), N23 is a reference point between the PCF and a network data analytics function (NWDAF), N24 is a reference point between the NSSF and the NWDAF, N27 is a reference point between a network repository function (NRF) in the visited network and the NRF in the home network, N31 is a reference point between NSSF in the visited network and NSSF in the home network, N32 is a reference point between security protection proxy (SEPP) in the visited network and SEPP in the home network, N33 is a reference point between a network exposure function (NEF) and the AF, N40 is a reference point between the SMF and a charging function (CHF), and N50 is a reference point between the AMF and a circuit bearer control function (CBCF).

Meanwhile, in FIG. 6C, for convenience of description, a reference model for a case in which the UE accesses one DN using one PDU session is illustrated, but is not limited thereto.

In the following, for convenience of description, it is described based on the EPS system using an eNB, the eNB may be replaced with components of 5G system using gNB, the mobility management (MM) function of the MME may be replaced with components of 5G system using AMF, the SM function of S/P-GW may be replaced with components of 5G system using SMF, the user plane-related functions of S/P-GW may be replaced with components of 5G system using UPF, and functions such as PCRF may be replaced with components of 5G system using PCF, etc.

FIG. 7 is an exemplary diagram illustrating a structure of a radio interface protocol in a control plane between a UE and an eNB, and FIG. 8 is an exemplary diagram illustrating a structure of a radio interface protocol in a user plane between a UE and an eNB.

The radio interface protocol is based on 3GPP radio access network standard. The radio interface protocol is horizontally composed of a physical layer, a data link layer, and a network layer, and is vertically divided into the user plane for transmitting data information and the control plane for transferring a control signal.

The protocol layers may be divided into L1 (a first layer), L2 (a second layer), and L3 (a third layer) based on the lower three layers of the open system interconnection (OSI) reference model, which is widely known in communication systems.

In the following, each layer of the radio protocol of the control plane shown in FIG. 7 and the radio protocol of the user plane shown in FIG. 8 will be described.

The first layer, the physical layer, provides an information transfer service using a physical channel. The physical layer is connected to an upper medium access control layer through a transport channel, and data between the medium access control layer and the physical layer is transferred through the transport channel. In addition, data is transferred between different physical layers, that is, between the physical layers of the transmitting side and the receiving side through the physical channel.

The physical channel is composed of several subframes on the time axis and several subcarriers on the frequency axis. Here, one subframe is composed of a plurality of OFDM symbols and a plurality of subcarriers on the time axis. One subframe is composed of a plurality of resource blocks, and one resource block is composed of a plurality of OFDM symbols and a plurality of subcarriers. The transmission time interval (TTI), which is a unit time for transmitting data, is 1 ms corresponding to one subframe.

According to 3GPP LTE, the physical channels existing in the physical layer of the transmitting side and the receiving side may be divided into data channels Physical Downlink Shared Channel (PDSCH) and Physical Uplink Shared Channel (PUSCH) and control channels Physical Downlink Control Channel (PDCCH), Physical Control Format Indicator Channel (PCFICH), Physical Hybrid-ARQ Indicator Channel (PHICH), and Physical Uplink Control Channel (PUCCH), etc.

There are several layers in the second layer. First, the medium access control (MAC) layer of the second layer plays a role of mapping various logical channels to various transport channels, and also performs a role of logical channel multiplexing that maps several logical channels to one transport channel. An MAC layer is connected to an RLC layer, which is the upper layer, through a logical channel, and the logical channels are largely divided into a control channel for transmitting information of the control plane and a traffic channel for transmitting information of the user plane according to the type of information to be transmitted.

The radio link control (RLC) layer of the second layer plays a role of adjusting the data size so that the lower layer is suitable for transmitting data over the wireless section by segmentation and concatenation of the data received from the upper layer.

The Packet Data Convergence Protocol (PDCP) layer of the second layer performs a header compression function that reduces the size of an IP packet header that contains relatively large and unnecessary control information for efficient transmission in the wireless section with small bandwidth when transmitting IP packets such as IPv4 or IPv6. In addition, in the LTE system, a PDCP layer also performs a security function, which consists of ciphering to prevent data wiretapping by a third party and integrity protection to prevent data manipulation by the third party.

A radio resource control (hereinafter abbreviated as RRC) layer located at the top of the third layer is defined only in the control plane, and is responsible for controlling logical channels, transport channels, and physical channels in relation to configuration, re-configuration, and release of radio bearers (abbreviated as RB). In this case, the RB means a service provided by the second layer for data transfer between the UE and the E-UTRAN.

When the RRC connection is established between the RRC of the UE and the RRC layer of the radio network, the UE is in an RRC connected mode, otherwise it is in an RRC idle mode.

Hereinafter, an RRC state of the UE and an RRC connection method will be described. The RRC state refers to whether the RRC of the UE is in a logical connection with the RRC of the E-UTRAN, and when it is connected, it is called an RRC_CONNECTED state, and when it is not connected, it is called an RRC_IDLE state. Since the UE in the RRC_CONNECTED state has the RRC connection, the E-UTRAN may grasp the existence of the UE at the cell level, and thus may effectively control the UE. On the other hand, for the UE in the RRC_IDLE state, the E-UTRAN cannot grasp the existence of the UE, and is managed by the core network in a unit of a tracking area (TA), which is a larger area unit than the cell. That is, the UE in the RRC_IDLE state is only grasped whether the UE exists in a larger area unit than the cell, and the corresponding UE must transition to the RRC_CONNECTED state in order to receive normal mobile communication services such as voice and data. Each TA is classified through a tracking area identity (TAI). The UE may configure the TAI through a tracking area code (TAC), which is information broadcasted from the cell.

When the user first turns on the power of the UE, the UE first searches for an appropriate cell, then establishes the RRC connection in the cell, and registers the information of the UE in the core network. After that, the UE stays in the RRC_IDLE state. The UE staying in the RRC_IDLE state (re)selects a cell as necessary, and looks at system information or paging information. This is called camping on the cell. The UE that has stayed in the RRC_IDLE state finally establishes the RRC connection with the RRC of the E-UTRAN through an RRC connection procedure, and then transitions to the RRC_CONNECTED state when it is necessary to establish the RRC connection. There are several cases where the UE in the RRC_IDLE state needs to establish the RRC connection, for example, cases where a user needs to attempt a call, attempt to transmit data, etc., or when a paging message is received from E-UTRAN, the cases of transmitting a response message for this.

The non-access stratum (NAS) layer located above the RRC layer performs functions such as session management and mobility management.

The NAS layer shown in FIG. 7 will be described in detail below.

The evolved session management (ESM) belonging to the NAS layer performs functions such as default bearer management and dedicated bearer management, and is responsible for controlling the UE to use PS services from the network. The default bearer resource has the characteristic that it is allocated from the network when connected to the network when connecting to a specific Packet Data Network (PDN) for the first time. At this time, the network allocates an IP address available to the UE so that the UE can use the data service, and also allocates QoS of the default bearer. LTE largely supports two types of bearers with guaranteed bit rate (GBR) QoS characteristics that guarantee a specific bandwidth for data transmission/reception, and non-GBR bearers with best effort QoS characteristics without guaranteeing bandwidth. In the case of the default bearer, the non-GBR bearer is allocated. In the case of the dedicated bearer, the bearer having QoS characteristics of GBR or Non-GBR may be allocated.

The bearer allocated to the UE in the network is called an evolved packet service (EPS) bearer, and when allocating the EPS bearer, the network allocates one ID. This is called an EPS bearer ID. One EPS bearer has QoS characteristics of a maximum bit rate (MBR) or/and a guaranteed bit rate (GBR).

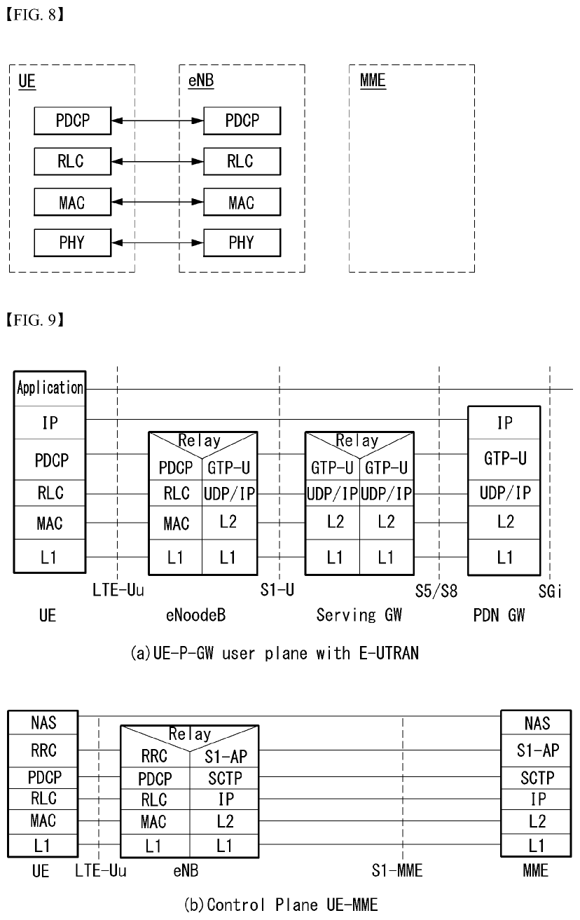

FIG. 9 illustrates LTE protocol stacks for a user plane and a control plane. FIG. 9(a) illustrates user plane protocol stacks over UE-eNB-SGW-PGW-PDN, and FIG. 9(b) illustrates control plane protocol stacks over UE-eNB-MME-SGW-PGW. A brief description of functions of key layers of the protocol stacks is as follows.

Referring to FIG. 9(a), a GTP-U protocol is used to forward user IP packets over the S1-U/S5/X2 interface. When a GTP tunnel is established for data forwarding during LTE handover, an end marker packet is transferred as the last packet over the GTP tunnel.

Referring to FIG. 9(b), an S1AP protocol is applied to an S1-MME interface. The S1AP protocol supports functions such as S1 interface management, E-RAB management, NAS signaling transfer, and UE context management. The S1AP protocol transfers the initial UE context to the eNB to set up E-RAB(s), and then manages modification or release of the UE context. A GTP-C protocol is applied to S11/S5 interfaces. The GTP-C protocol supports an exchange of control information for generation, modification and termination of the GTP tunnel(s). The GTP-C protocol generates data forwarding tunnels in case of the LTE handover.

The description of the protocol stacks and interfaces illustrated in FIGS. 7 and 8 may be applied to the same protocol stacks and interfaces of FIG. 9 as it is.

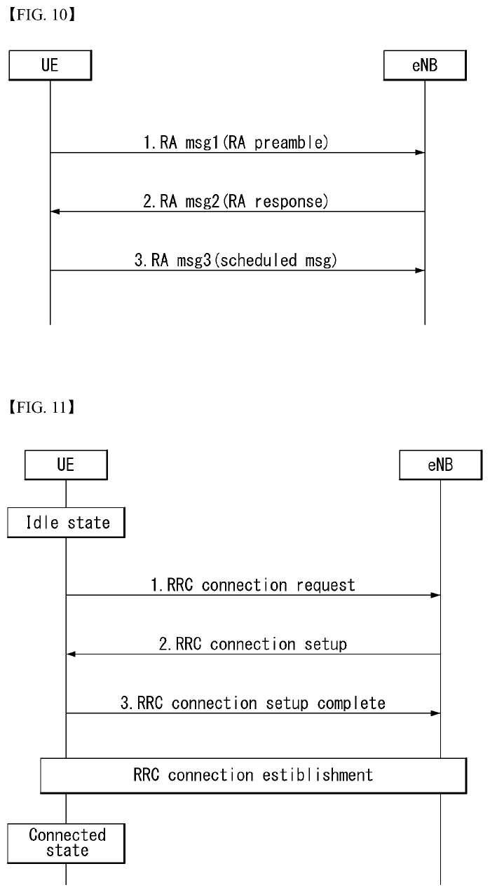

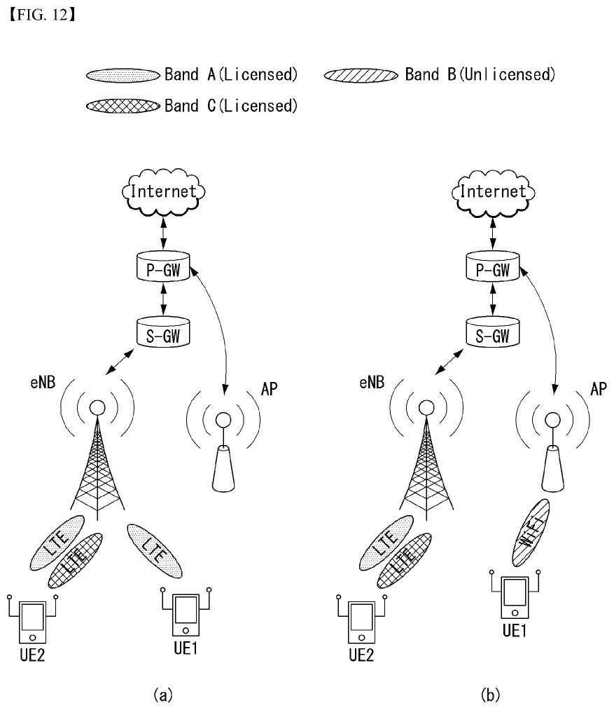

FIG. 10 is a flowchart illustrating a random access procedure in 3GPP LTE.

The random access procedure is performed for the UE to obtain UL synchronization with the base station or to be allocated UL radio resources.

The UE receives a root index and a physical random access channel (PRACH) configuration index from the eNB. Each cell has 64 candidate random access (RA) preambles defined by a Zadoff-Chu (ZC) sequence, and the root index is a logical index for the UE to generate 64 candidate random access preambles.

Transmission of the random access preamble is limited to specific time and frequency resources for each cell. A PRACH configuration index indicates a specific subframe and preamble format in which the random access preamble can be transmitted.

The random access procedure, in particular, the contention-based random access procedure includes the following three steps. Messages transmitted in the following Steps 1, 2, and 3 are also referred to as msg1, msg2, and msg4, respectively.

1. The UE transmits a random access preamble selected at random to the eNB. The UE selects one of 64 candidate random access preambles. Then, the UE selects the corresponding subframe by the PRACH configuration index. The UE transmits the selected random access preamble in the selected subframe.

2. The eNB that has received the random access preamble sends a random access response (RAR) to the UE. The random access response is detected in two steps. First, the UE detects a PDCCH masked with a random access-RNTI (RA-RNTI). The UE receives a random access response in a Medium Access Control (MAC) Protocol Data Unit (PDU) on the PDSCH indicated by the detected PDCCH. The RAR includes timing advance (TA) information indicating timing offset information for UL synchronization, UL resource allocation information (UL grant information), and a temporary UE identifier (e.g. temporary cell-RNTI, TC-RNTI), and the like.

3. The UE may perform UL transmission according to resource allocation information (i.e. scheduling information) and TA values in the RAR. HARQ is applied to the UL transmission corresponding to the RAR. Accordingly, after performing the UL transmission, the UE may receive reception response information (e.g. PHICH) corresponding to the UL transmission.

FIG. 11 illustrates a connection procedure in a radio resource control (RRC) layer.

As shown in FIG. 11, an RRC state is shown according to whether an RRC is connected. The RRC state refers to whether an entity of the RRC layer of the UE is in a logical connection with an entity of the RRC layer of the eNB, and when connected, it is referred to as an RRC connected state, and the state that is not connected is referred to as an RRC idle state.

Since the UE in the connected state has the RRC connection, the E-UTRAN may grasp the existence of the corresponding UE at the cell level, and thus may effectively control the UE. On the other hand, the UE in the idle state cannot be grasped by the eNB, and is managed by the core network in a unit of a tracking area, which is a larger area unit than the cell. The tracking area is a set unit of cells. That is, the idle state UE is only grasped whether the UE exists in a larger area unit, and the UE must transition to the connected state in order to receive normal mobile communication services such as voice or data.

When the user first turns on the power of the UE, the UE first searches for an appropriate cell and then stays in an idle state in the cell. When the UE that has stayed in the idle state needs to establish the RRC connection, it establishes the RRC connection with the RRC layer of the eNB through the RRC connection procedure and transitions to the RRC connected state.

There are various cases in which the UE in the idle state needs to establish the RRC connection, for example, cases in which a user needs to attempt a call or transmit uplink data, or when a paging message is received from the EUTRAN, case of transmission of a response message to this, etc.

In order for the UE in the idle state to establish the RRC connection with the eNB, it must proceed with the RRC connection procedure as described above. The RRC connection procedure largely includes a procedure in which the UE transmits an RRC connection request message to the eNB, a procedure in which the eNB transmits an RRC connection setup message to the UE, and a procedure in which the UE transmits an RRC connection setup complete message to the eNB. This procedure will be described in more detail with reference to FIG. 11 as follows.

1. When the UE in the idle state wants to establish the RRC connection for reasons such as a call attempt, a data transmission attempt, or a response to the eNB's paging, first, the UE transmits the RRC connection request message to the eNB.

2. When receiving the RRC connection request message from the UE, when the radio resources are sufficient, the eNB accepts an RRC connection request from the UE, and transmits the RRC connection setup message, which is the response message, to the UE.

3. When the UE receives the RRC connection setup message, it transmits the RRC connection setup complete message to the eNB.

When the UE successfully transmits the RRC connection setup message, the UE finally establishes the RRC connection with the eNB and transitions to the RRC connection mode.

A service request procedure is performed in order to transition to an active state in which new traffic is generated and the UE in the idle state can transmit/receive traffic. In the state that the UE is registered in the network, but the S1 connection is released due to traffic inactivation and radio resources are not allocated, that is, when the UE is in the EMM-registered state but in the ECM-idle state, when traffic to be transmitted by the UE occurs or traffic to be transmitted to the UE in the network occurs, when the UE requests a service from the network and successfully completes the service request procedure, the UE transitions to an ECM-connected state, and the UE transmits/receives traffic by configuring an ECM connection (RRC connection+S1 signaling connection) in the control plane and E-RAB (DRB and S1 bearers) in the user plane. When the network wants to transmit traffic to the UE in the ECM-idle state, it first informs the UE that there is traffic to be transmitted through a paging message so that the UE can make a service request.

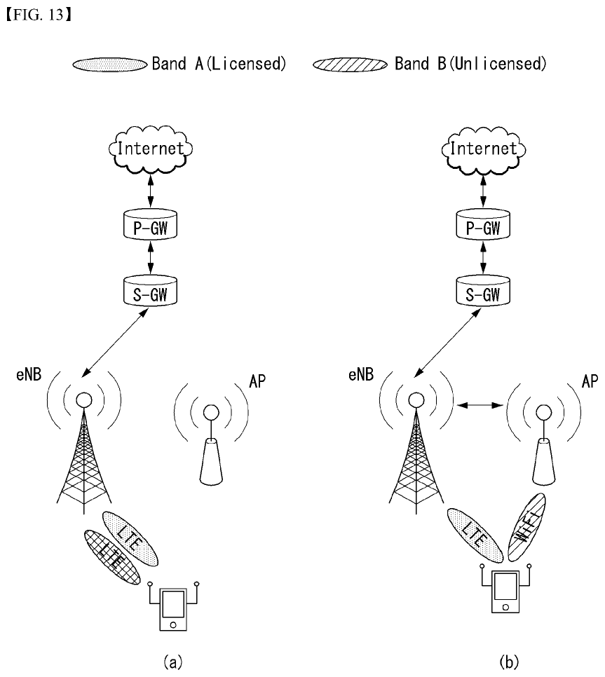

FIG. 12 illustrates a flow of (downlink/uplink) signals between a UE and a network node(s) in a conventional system.

In the case of downlink signal transmission, P-GW sends signals to be sent through LTE technology to S-GW/eNB, and sends signals to be sent through WiFi technology to a WiFi access point (AP) (without going through S-GW and eNB). The UE receives a signal for the UE using LTE technology on one or more licensed bands, or receives a signal for the UE using WiFi technology on an unlicensed band.

In the case of uplink signal transmission, signals using LTE technology are transferred to the P-GW through the eNB and the S-GW on the licensed band, and signals using WiFi technology are transferred to the P-GW through the AP (without going through the eNB and S-GW) on the unlicensed band.

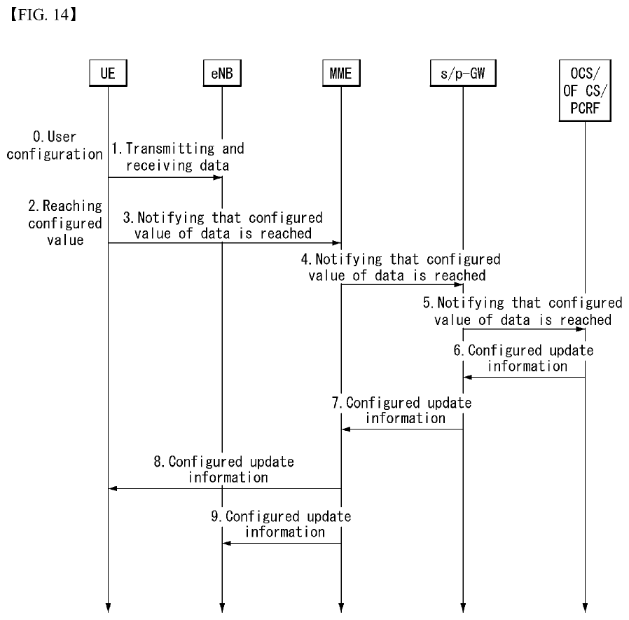

FIG. 13 illustrates a flow of (downlink/uplink) signals between a UE and a network node(s) in an improved system to which the present disclosure is applied. In particular, FIG. 13(a) is shown to explain a concept of licensed assisted access (LAA), and FIG. 13(b) is shown to explain a concept of LTE-WLAN aggregation (LWA).

Currently, in the WiFi system, an unlicensed band that is not dedicated to a specific operator is used for communication. In this unlicensed band, any wireless technology may be used when using a certain standard, for example, when a technology that does not cause or minimize interference to a wireless channel is adopted, and a certain output power or less. Therefore, there is a movement to apply the technology currently used in the cellular network to the unlicensed band, which is called LAA. The introduction of LAA into the LTE system is being considered to increase user satisfaction by providing services in unlicensed bands, as the number of users using mobile data explodes, compared to the frequencies (i.e. licensed band(s)) currently owned by each wireless communication service operator. According to LAA, the LTE radio frequency can be extended to a frequency band not specified by 3GPP, that is, an unlicensed band. The WLAN band may be a main application target of LAA.

Referring to FIG. 13(a), when band A, which is a licensed band, and band B, which is an unlicensed band, are aggregated for the UE, the eNB may transmit a downlink signal directed to the UE to the UE using LTE technology on the band A, which is the licensed band or on the band B, which is the unlicensed band. Similarly, when the band A, which is the licensed band, and the band B, which is the unlicensed band, are aggregated for the UE, the uplink signal transmitted by the UE to the network may be transmitted from the UE to the eNB (or a remote radio header (RRH)/remote radio unit (RRU) of the eNB) using LTE technology on the band A, which is the licensed band or on the band B, which is the unlicensed band.

On the other hand, in an existing LTE system, even if a plurality of frequency bands are aggregated for communication with the UE, uplink/downlink communication between the UE and the network node was performed using only LTE technology on the plurality of frequency bands. In other words, the communication link that the UE can use at different frequencies at the same time was only the LTE link. As another method for reducing congestion on the licensed band, it is considered that communication between the UE and the network node is performed by simultaneously using the LTE technology and the WiFi technology at different frequencies. This technology is called LWA. According to the LWA, the WLAN radio spectrum and the WLAN AP are used for communication with the UE together with the LTE radio spectrum and LTE nodes (e.g. eNB, RRH, RRU, etc.).

Referring to FIG. 13(b), the eNB may directly transmit a downlink signal for the UE to the UE or may transmit it to the AP using the LTE technology on the band A, which is the licensed band configured for the UE. The eNB may send LTE data to the AP and control the AP. The AP may transmit a downlink signal for the UE to the UE using the WiFi technology on the band B, which is the unlicensed band, under control of the eNB. Similarly, when the band A, which is the licensed band, and the band B, which is the unlicensed band, is configured in the UE, the UE may directly transmit an uplink signal to the eNB using LTE technology on the band A, or may transmit it to the AP using WiFi technology on the band B. The AP transmits the uplink signal from the UE to the eNB controlling the AP.

If the unlicensed band can be used for communication with the licensed band, the operator may consider the following scenario:
Uses cellular technology (e.g. LTE) in the frequency allocated to the operator, and uses cellular technology in unlicensed bands (see FIG. 13(a)); and
Uses cellular technology (e.g. LTE) in the frequency allocated to the operator, and uses a technology such as WiFi in unlicensed bands (see FIG. 13(b)).

In either case, the operator may want to use both technologies at the same time. However, from the perspective of the operator, in the case of the frequency allocated to the operator, the operator pays a lot of money to acquire the frequency, but in the unlicensed band, the operator does not pay to receive the allocation. Therefore, when providing services to customers, the operator may want to have a different charging system when providing services on the allocated frequency (hereinafter, licensed band or LB), and when using an unlicensed band (hereinafter, UB).

By the way, according to the structure of LAA/LWA, the eNB directly exchanges data with the UE through cellular technology through the LB, and at the same time, exchanges data with the UE through WiFi technology through an AP connected to the eNB. However, in order to provide data to the UE at the fastest time, the current eNB decides which technology to use for the UE, considering only the quality of the radio channel, so that there arises a problem that the user of the UE has to pay a large amount of radio data fees than necessary.

That is, according to the current standard technology, charging is performed in the core (e.g. P-GW), and the charging is performed by simply calculating the amount of data, and the technology used between the eNB and the UE is not considered (see sections 5.3.6A and 5.6a of 3GPP TS 23.401, 3GPP TS 23.203). In addition, when data transmission/reception is performed using the existing WiFi technology, when the data uses a local GW (L-GW) and does not pass through the core (P-GW), charging is not performed. For example, assume that among the downlink data packets 1, 2, 3, 4, and 5 for the UE, downlink data packets 1 to 3 are transmitted/received on the licensed band, and downlink data packets 4 and 5 are transmitted/received on the unlicensed band. In the current LTE network, since the charging is performed in the P-GW, referring to FIG. 12, according to the system to date, among the downlink data packets 1 to 5, the downlink data packets 1 to 3 are branched from the charging node P-GW toward the eNB, and the downlink data packets 4 and 5 are branched to the AP. Accordingly, the charging node P-GW may know how many data packets use the licensed band of the LTE network, and data packets to be transmitted on the unlicensed band may be excluded from the charging. On the other hand, referring to FIG. 13, the P-GW sends all downlink data packets 1, 2, 3, 4, 5 to the S-GW and the eNB, and since the eNB allocates the downlink data packets 1, 2, 3, 4, 5 on the licensed band and the unlicensed band, there is a problem that the P-GW cannot accurately charge for the UE and deduct the quota.

In particular, the present disclosure proposes a system and method for differently charging according to the used wireless technology for a device that simultaneously uses/supports a wireless technology such as WiFi and a cellular-based wireless technology such as LTE. According to the present disclosure, the load on the UE can be effectively controlled depending on the type of radio access technology and/or radio band.

For reference, according to the current standard technology, P-GW collects or processes charging information, and the actual charging information is stored in a charging system. Since the P-GW cannot store all charging information that occurs during a period of one month, the P-GW generates/processes charging information, and actual storage, rate conversion, and the like are performed in the charging system. Physically, the P-GW and charging system may be implemented as one. In the present disclosure, the charging node may mean a node equipped with the charging system or a node connected to the charging system. In the following, the present disclosure is mainly described on the assumption that the P-GW is a charging node, but the present disclosure related to the P-GW is applied regardless of the name of a network node having a charging function. Therefore, the charging node may be an existing P-GW, and another node, e.g. a local GW (L-GW), having the charging function or connected to the charging system. In addition, the present disclosure is described on the premise that the communication using the LTE technology goes through charging GW, but the present disclosure may be applied to the LTE communication using the unlicensed band through the charging GW.

The present disclosure proposes to exchange information related to radio access technology for processing traffic between network nodes in order for the eNB to efficiently perform scheduling to the UE. For example, information related to radio access technology may include the following information.
Information related to the radio access technology (e.g. LTE, WiFI, etc.) permitted to be used by the UE:

Information on whether the eNB should transmit/receive data using only LTE in the procedure of exchanging data with the UE;

Information on whether the eNB should transmit/receive data using only WiFi in the procedure of exchanging data with the UE; and/or

Information on whether the eNB should transmit/receive data using only LB or UB in the procedure of exchanging data with the UE.
Information related to radio frequencies/bands permitted to be used by the UE.
For the combination of the radio access technology and radio frequency/band, the amount of data the UE can use:

Total amount of data that can be transmitted using LTE technology, using LB or UB, in downlink or uplink to the UE; and/or

Total amount of data that can be transmitted using WiFi technology, using LB or UB, in downlink or uplink to the UE.
Criteria for examining and reporting events related to data transmission/reception of the UE:

Information related to whether the report should be performed to the MME or S-GW, etc. each time how much data is transmitted, in the procedure that the eNB exchanges data with the UE; and/or

Information related to whether the report should be performed to the MME or S-GW, etc. each time how much data is transmitted, each downlink/uplink, each LTE technology/WiFi technology, each LB/UB, in the procedure that the eNB exchanges data with the UE.

For example, when the total amount of data exchanged by the eNB with the UE reaches the total amount of data allowed for the designated transmission, the information related to the radio access technology may be transferred in the procedure in which the MME transfers the context of the UE to the eNB. The eNB, or each network node, the UE receiving the information above operate as intended by the information as mentioned above.

1) Case where Data Usage is Blocked when Maximum Usage is Reached

In the above process, when the user (in various cases) configures the maximum data usage, and when the actual data usage of the terminal reaches the maximum data usage configured as above, the terminal may first notify a first node of the network that the maximum data usage configured by the user has been reached, and allow the network to reconfigure the communication environment.

FIG. 14 is a diagram illustrating a case in which a user blocks data use when a configured maximum usage is reached according to an embodiment of the present disclosure.

0. The maximum data usage value of the terminal is configured by the user.

1. The terminal transmits and receives data with the base station (eNB), and the terminal measures the data usage value.

2. The amount of data used by the terminal reaches the value previously configured by the user in Step 0.

3. The terminal transfers information that the amount of data configured by the user has been reached to the first node of the network. For example, the NAS messages and the like may be used, and the first node may be formed of the MME. The message transmitted by the terminal to the first node may be expressed in various ways, for example, information that the amount of data configured by the user has been reached may be transferred, or it is also possible to request the configuration of the communication environment or the change of the Quality of Service (QoS) from the network. For example, it is possible other expressions such as asking to configure a different RAT instead of a mobile network (e.g. LTE, 5G RAN), or to configure a bearer of low QoS.

4. The first node may additionally transfer the information received through Step 3 to a second node in the network. For example, in order to transfer information to PCRF, which is a node that manages a policy that configures communication environment values, or Online Charging System (OCS)/Offline Charging System (OFCS) in charge of charging, or P-GW that determines actual data routing or performs bearer mapping, etc., the first node that first receives information from the terminal may forward the information to the second node. As described in Step 3 above, in order to achieve the same effect, the expression of information may be different.

5. It has the same use as in Step 4 above, and is a procedure of transferring information to additional nodes. If Step 4 is sufficient, Step 5 may be omitted.

6. Based on Step 5 above, the nodes of the network recognize that the maximum data usage configured by the terminal has been reached, and start changing the communication configuration based on this. For example, further data transmission using a mobile network (e.g. LTE, 5G RAN) may be prohibited, or data transmission in the future may use an unlicensed band.

7. The configuration change information received through Step 6 may be used, or the second node may start the configuration change by itself based on the information received through Step 4. Information on this is additionally transferred to the first node through Step 7.

8. When it is necessary to notify the terminal about the configuration change, the first node updates the terminal configuration through Step 8. For example, it may notify the QoS information of a communication service to be provided in the future. For example, due to the use of an unlicensed band, it may notify that the quality of a service such as a voice call may deteriorate.

9. The first node notifies a node managing radio resources of the configuration change. For example, the node managing radio resources may be a base station (eNB), through this, the node managing radio resources may stop allocating radio resources through a mobile network (e.g. LTE, 5G RAN), and may use only the unlicensed band for data transmission and reception in the future depending on the configuration change.

2) Case where User Block Data Use

In the above procedure, when the user (in various cases) configures the maximum data usage, and when the actual data usage used by the terminal reaches the maximum data usage configured as above, the terminal may first block data transmission in the uplink direction, additionally notify the first node that the data transmission has been blocked, and enable the nodes of the network to reconfigure the communication environment. Compared to the method of 1) above, this method has an effect of preventing additional use of data that may occur while nodes of the network reconfigure the environment because the terminal actively blocks the data use. However, it may even worsen the user experience due to communication disconnection that may occur while nodes of the network reconfigure the communication environment.

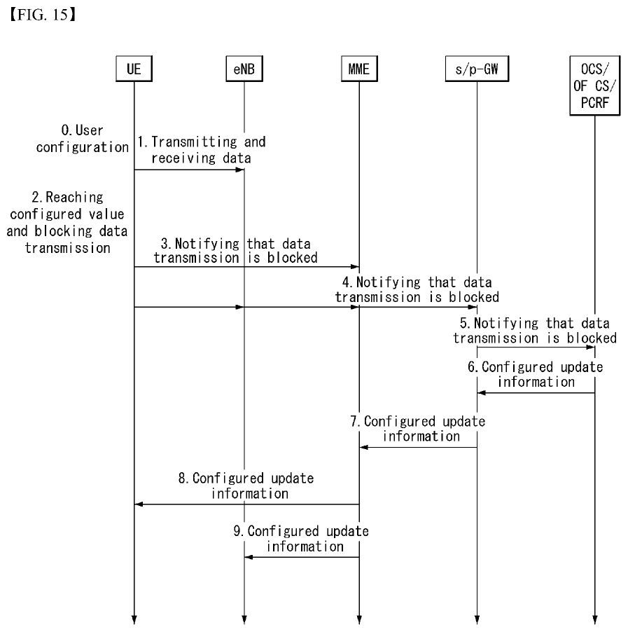

FIG. 15 is a diagram illustrating a case in which a user blocks data use according to an embodiment of the present disclosure.

0. The maximum data usage value of the terminal is configured by the user.

1. The terminal transmits and receives data with the base station (eNB), and the terminal measures the data usage value.

2. The amount of data used by the terminal reaches the value previously configured by the user in Step 0. The terminal immediately blocks data transmission in the uplink direction.

3. The terminal transfers information that data transmission is blocked because the amount of data configured by the user has been reached to the first node of the network. For example, the NAS messages and the like may be used, and the first node may be formed of the MME. The message transmitted by the terminal to the first node may be expressed in various ways, for example, information that the data transmission is blocked because the amount of data configured by the user has been reached may be transferred, or it is also possible to request the configuration of the communication environment or the change of the Quality of Service (QoS). For example, it is possible other expressions such as asking to configure a different RAT instead of a mobile network (e.g. LTE, 5G RAN), or to configure a bearer of low QoS.

By the way, in Step 3, the terminal may directly transmit a message to the core network, transmit a message to the node managing radio resources, and use both. The terminal may block the uplink data by itself, but since the node managing radio resources that are not aware of this may continuously transmit downlink data until reconfiguration is performed, to prevent this, the terminal may request the node managing radio resources to stop transmitting the downlink data, and the node managing radio resources that has received this may stop transmitting data in the downlink direction. Based on this, the node managing radio resources may additionally notify the core network of this fact and may trigger the core network to reconfigure the communication environment.

4. The first node may additionally transfer the information received through Step 3 to the second node in the network. For example, in order to transfer information to PCRF, which is a node that manages a policy that configures communication environment values, or OCS/OFCS in charge of charging, or P-GW that determines actual data routing or performs bearer mapping, etc., the first node that first receives information from the terminal may forward the information to the second node. As described in Step 3 above, in order to achieve the same effect, the expression of information may be different. Based on this, nodes such as P-GW and S-GW may temporarily stop data transmission until the communication environment is reconfigured.

5. It has the same use as in Step 4 above, and is a procedure of transferring information to additional nodes. If Step 4 is sufficient, Step 5 may be omitted.

6. Based on Step 5 above, the nodes of the network recognize that the terminal has blocked data transmission, and start changing the communication configuration based on this. For example, further data transmission using LTE may be prohibited, or data transmission in the future may use an unlicensed band.

7. The configuration change information received through Step 6 may be used, or the second node may start the configuration change by itself based on the information received through Step 4. Information on this is additionally transferred to the first node through Step 7.

8. When it is necessary to notify the terminal about the configuration change, the first node updates the terminal configuration through Step 8. For example, it may notify the QoS information of a communication service to be provided in the future. For example, due to the use of an unlicensed band, it may notify that the quality of a service such as a voice call may deteriorate. In particular, through this procedure, the terminal that has received the corresponding message may release the blocking of uplink transmission and start transmission again.

9. The first node notifies the node managing radio resources of the configuration change. For example, the node managing radio resources may be a base station (eNB), through this, the node managing radio resources may stop allocating radio resources through a mobile network (e.g. LTE, 5G RAN), and may use only the unlicensed band for data transmission and reception in the future, depending on the configuration change. By the instruction of the terminal, the node managing radio resources that has blocked data transmission in the downlink direction may resume data transmission.

3) Case where the Terminal Notifies the Network of Data Usage Configuration Information

In 1) and 2) above, it was determined whether the data was blocked or whether the maximum data usage was reached, based on the calculation of the terminal. However, as a different method, the terminal may notify the maximum data usage information configured by the user to the first node of the network, and the nodes of the network may use a method of updating the communication environment when a certain standard is reached based on this. That is, due to a delay in transferring in the uplink and downlink directions or a difference in the data usage calculation method, there are cases where the data usage calculated by the nodes of the network and the amount of data used by the terminal are different, in particular, considering that charging is made based on the data usage calculated by the nodes of the network, when the nodes of the network monitor usage, and this usage reaches the value configured by the user, which is a method that the nodes of the network reconfigure the communication environment.

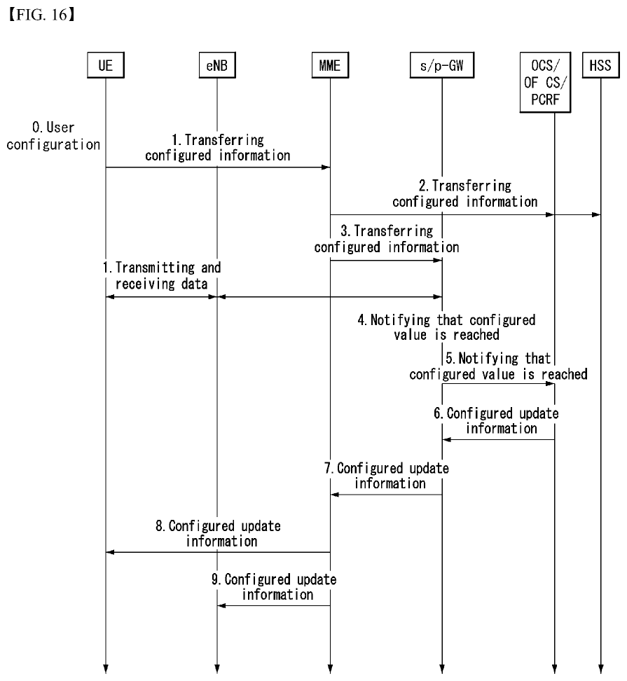

FIG. 16 is a diagram illustrating a case in which a user blocks data use when a configured maximum usage is reached according to an embodiment of the present disclosure.

0. The maximum data usage value of the terminal is configured by the user.

1. The terminal transfers configuration information including the maximum data usage value configured by the user to the first node of the network. For example, the first node may be an MME. Such configuration information may include information related to a terminal access method.

2. The first node of the network transfers the configuration information configured by the user to a subscriber information management module. For example, the subscriber information management module may be a Home Subscriber Server (HSS). Based on this, the subscriber information management module updates terminal-related items. In addition, the first node may transfer a value configured by the user to PCRF, which is a node that manages a policy that configures communication environment values, or OCS/OFCS in charge of charging, etc., if necessary.

3. The first node of the network, which has received the information in Step 1, transfers the user's configuration value to another required second node. For example, the second node may be p-GW and/or s-GW.

4. The second node measures the data usage of the terminal and reaches a value designated by the user.

5. The second node notifies other nodes of the network that data usage has reached the value designated by the user. Based on this, it is also possible to trigger the core network to update the communication environment. For example, information may be transferred to PCRF, which is a node that manages a policy that configures communication environment values, or OCS/OFCS in charge of charging, etc., and the communication environment update may be triggered based on this.

6. Based on Step 5 above, the nodes of the network start changing the communication environment configuration. For example, further data transmission using a mobile network (e.g. LTE, 5G RAN) may be prohibited, or data transmission in the future may use an unlicensed band.

7. The configuration change information received through Step 6 may be used, or the node that recognizes Step 4 may start the configuration change by itself. Information on this is additionally transferred to the first node through Step 7.

8. When it is necessary to notify the terminal about the configuration change, the first node updates the terminal configuration through step 8. For example, it may notify the QoS information of a communication service to be provided in the future. For example, due to the use of an unlicensed band, it may notify that the quality of a service such as a voice call may deteriorate. In particular, through this procedure, the terminal that has received the corresponding message may release the blocking of uplink transmission and start transmission again.

9. The first node notifies the node managing radio resources of the configuration change. For example, the node managing radio resources may be a base station (eNB), through this, the node managing radio resources may stop allocating radio resources through, for example, a mobile network (e.g. LTE, 5G RAN), and may use only the unlicensed band for data transmission and reception in the future, depending on the configuration change. By the instruction of the terminal, the node managing radio resources that has blocked data transmission in the downlink direction may resume data transmission.

On the other hand, downlink data arriving at the P-GW in the existing LTE system is transferred to the eNB through the S-GW, and uplink data transmitted by the UE goes through the eNB and the S-GW and then through the P-GW. In this procedure, data filtering, packet classification, and charging information management are performed by the S-GW or P-GW. This may be based on an access method currently being used or intended to be used by the UE, and information related to the access method of the terminal may be obtained by packets transferred from the UE. However, when data transmission to the UE through a cellular technology such as LTE reaches a predetermined limit (e.g. data quota), if the UE may use WiFi or use UB, it is recommended that data transmission to the UE is not blocked or filtered. Therefore, information related to radio access may be exchanged between the eNB and the S-GW/P-GW so that the S-GW or P-GW may appropriately determine the data processing. Whenever the P-GW or S-GW transfers a user data packet to the eNB, the P-GW or S-GW may exchange information related to radio access together with the data packet. The information related to the radio access may include the following information.
Radio access technology information that can be used when the data packet is transferred to the UE: For example, information about whether the eNB should use only LTE or only WiFi.
When the data packet is transferred to the UE, information on the available frequency band: For example, information about whether the eNB should use only LB or only UB.
Information on resources used in data packets in the actual wireless section: For example, the eNB transfers information on the amount of data packets transferred to the user through the LTE or WiFi to the S-GW or P-GW or MME whenever a certain criterion is satisfied. For example, the eNB transfers information on the amount of data packets transferred to the user through the LB or UB to the S-GW or P-GW or MME whenever a certain criterion is satisfied.

Based on such radio access-related information, the P-GW or S-GW may change information on data that it sends to downlink. For example, the P-GW or S-GW may command the eNB not to use a specific radio access technology or a specific frequency for data transmission. Alternatively, the P-GW or S-GW may mark the information it transfers together with the data packet in consideration of the above situation. In this case, the P-GW or S-GW may transfer a command to the eNB through the MME. Whenever the eNB receives an uplink user data packet from the UE and transfers it to the P-GW/S-GW, the eNB may transfer the following information together with each data packet.
Radio access technology information used when the data packet is received from the UE: For example, information on whether the packet from the UE was received using LTE or WiFi.
Information on the frequency band used when the data packet is received from the UE: For example, information on whether the packet from the UE was received using LB or UB.

Based on the above-described radio access-related information, the P-GW or S-GW may order not to use LTE any more, for example, if the amount of data that can be transfer red using LTE allocated to a certain UE is exceeded. The eNB or each network node, the UE, which has received the above-described radio access-related information, operates as intended by the information as mentioned above.

It is recommended that the UE grasp a case in which it has exhausted all of its quota for transmitting/receiving radio data through the cellular radio access technology or LB and notify the user of it accordingly. For example, the UE may notify information such as whether there is an available UB or not. When using LAA/LWA simultaneously with LTE, the UE may indicate this to the user. For example, the UE displays the signal indication of the cellular network and the WiFi indication on the display device together. Alternatively, when using cellular communication using LAA, for example, UB, the UE displays this on the display device of the UE. The eNB may notify whether each cell supports LAA/LWA in the corresponding cell through a system information block (SIB) or RRC signaling, etc. For example, the eNB may notify the UE attached to itself of that a cell operating on an unlicensed band can be configured as a serving cell for the UE.

The UE may use UB or WiFi technology even if it exhausts all the cellular radio resource quota, and if the quota for UB or WiFi is still remaining, it is preferable that the UE is allowed to access the network using UB or WiFi with remaining quota. To this end, the UE may transfers information on its preferred access method through configuration information transmission, or performing an RRC connection procedure with an eNB, or in a service request procedure with an MME (see section 5.3.4 of 3GPP TS 23.401). The information on the access method preferred by the UE may include the following information.
Radio access technology information that the UE intends to use for data packet transmission: For example, information about whether the UE wants to use only LTE, or only WiFi, or which one prefers.
Information on the frequency band that the UE wants to use for data packet transmission: For example, information about whether the UE wants to use only LB or only UB, or which one prefers.

The eNB or MME may configure a connection with the UE based on the information on the UE's preferred access method. The eNB or MME may notify UE of the configuration result. For example, the eNB or the MME may notify the UE whether the actual user data transmission/reception uses only LTE, only WiFi, or both. For example, the eNB or the MME may notify the UE whether the actual user data transmission/reception uses only LB, only UB, or both. In other words, when the UE accesses the network using a specific radio technology A, it notifies the network that it wants to transmit data using another specific radio technology B. For example, the UE may perform a wireless connection procedure of LTE, and then transmit/receive data using WiFi wireless technology other than LTE through the eNB, and receive the control signal through LTE. The eNB, or each network node, the UE, which has received information on the UE's preferred access method, operates as the information intended as described above.

In the case of a VoIP call such as a VoLTE call through the path of P-GW<->S-GW<->eNB<->UE, for the purpose of stable service management and QoS control, information on which radio access technology the corresponding VoLTE call is transmitted is needed in the IMS network or the core network and needs to be controlled accordingly. For the EPS bearer, the eNB may utilize information on whether data of the corresponding EPS bearer should be transmitted only through WiFi or LTE, or whether it doesn't matter which wireless technology is used. To this end, the MME may transfer information on the EPS bearer to be configured to the eNB, and at the same time, propose to provide information on a preferred radio access technology (e.g. LTE, WiFi), and information on a preferred radio band (e.g. LB, UB), etc. for the corresponding EPS bearer. As another method, for each EPS bearer, after going through the configuration and update procedure, the eNB may notify MME, S-GW, P-GW, PCRF, CSCF, PCEF, etc. of information on which radio access technology (e.g. LTE, WiFi, etc.) the corresponding EPS bearer is being transmitted. In the above procedure, the eNB may transfer information on the EPS bearer directly, or indirectly via other nodes. Here, the proposal of the present disclosure may be similarly applied to the radio bearer, which is a bearer connecting the eNB and the UE, instead of the EPS bearer, which is a bearer connecting the UE and the P-GW. This information transfer may also be performed at IMS nodes (e.g. P-CSCF, S-CSCF, I-CSCF, etc.) and AS nodes (e.g. application node at the top of the core network) as well as MME, S-GW, P-GW, PCRF, CSCF, PCEF. In the above procedure, the intended information, for example, information on the type of band to be used (e.g. whether it is LB or UB), and information on the radio access technology used, may be additionally transferred for each service provided in the IMS domain. Services provided through the IMS domain include a voice call service through an IMS voice call (MMTEL Voice), and a video call service provided through an IMS video call (MMTel Video) IMS, etc. The information intended in the above procedure is not collectively designated for all services provided through IMS, but for each IMS voice and IMS video, for example, information about preference for LB/UB or designation for WiFI/LTE may be transferred.

Meanwhile, the UE may not have an LTE quota, but may not have a WiFI quota. In this case, if there is an eNB that supports WiFi, the UE should be able to perform connection with the eNB. The eNB should be able to prevent transmitting data to the UE through LTE. To this end, in the present disclosure, in the procedure of establishing an RRC connection by the UE, for the UE, it is proposed to transmit information on whether the UE wants to use only LTE, or WiFi, or whether the UE wants to use both to the eNB or the MME.

The charging node (or charging system) of the present disclosure may perform different charging for the UE depending on the radio access technology (e.g. LTE, WiFi) and/or the type of band (e.g. LB, UB) used between the eNB and the UE for data transmission/reception. To this end, the present disclosure provides the above-described charging assistance information to the charging node. The charging assistance information may include an amount of data transmitted/received through a specific radio access technology, an amount of data transmitted/received through a specific type of band, and the like.

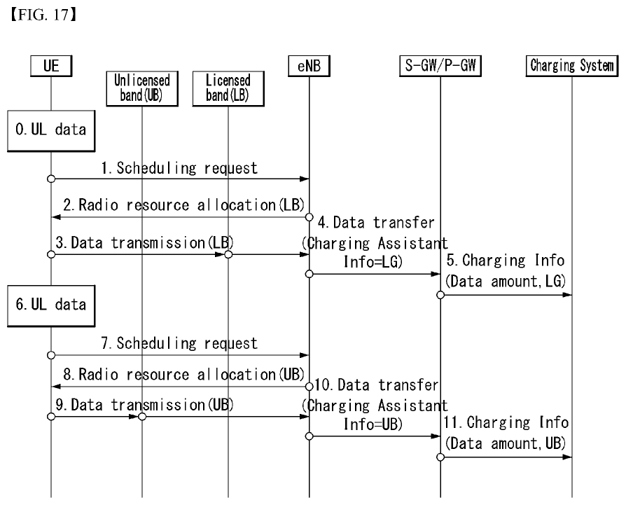

FIG. 17 illustrates a procedure of transmitting/receiving data according to the present disclosure. In particular, FIG. 17 illustrates a procedure of transmitting/receiving UL data.

0. UL data to be transmitted to the network is generated to the UE.

1. The UE notifies the eNB that there is data generated in Step 0, that is, that there is uplink (UL) data to be transmitted to the network.

2. The eNB allocates radio resources for UL data transmission to the UE. For example, the eNB may command the UE to transmit data through the LB.

After completing this step, when the UE is able to transmit the UL data through the LB, the UE may display charging information (i.e. charging information for data usage when transmitting the UL data through the LB) using a pop-up window or the like.

3. The UE transmits data through the radio resource indicated in Step 2. For example, when the eNB commands the UE to transmit data through the LB, that is, when the LB is allocated as a data transmission resource, the UE transmits UL data through the LB, as indicated in Step 2.

4. The eNB transfers the UL data received in step 3 to the S-GW/P-GW. At this time, the eNB transfers information indicating that the corresponding UL data has been received through the LB together as charging assistance information.

5. The P-GW/S-GW forwards the UL data received from the eNB to an external network, and at the same time, using the charging assistance information received together with the UL data, the P-GW/S-GW transfers information indicating that the corresponding data has been transferred using the LB to the charging system together with information about the amount of data transferred.

6. UL data to be transmitted back to the network may be generated to the UE.

7. The UE notifies the eNB that there is data generated in Step 6, that is, that there is UL data to be transmitted to the network.

8. The eNB allocates radio resources for transmission of UL data generated in Step 6. For example, in Step 8, when the UE notifies that the UB has better channel quality than the LB, the eNB commands the UE to transmit data through the UB.

After completing this step, when the UE is able to transmit the UL data through the UB, the UE may display charging information (i.e. charging information for data usage when transmitting the UL data through the UB) using a pop-up window or the like.

9. The UE transmits the UL data through the UB as indicated in Step 8.

10. The eNB transfers the data received in Step 9 to the S-GW/P-GW. At this time, the eNB transfers information indicating that the corresponding UL data has been received through the LB together as charging assistance information.

11. The P-GW/S-GW forwards the data received from the eNB to an external network, and at the same time, using the charging assistance information received together with the data, the P-GW/S-GW transfers information indicating that the corresponding data has been transferred using the UB to the charging system together with information about the amount of data transferred.

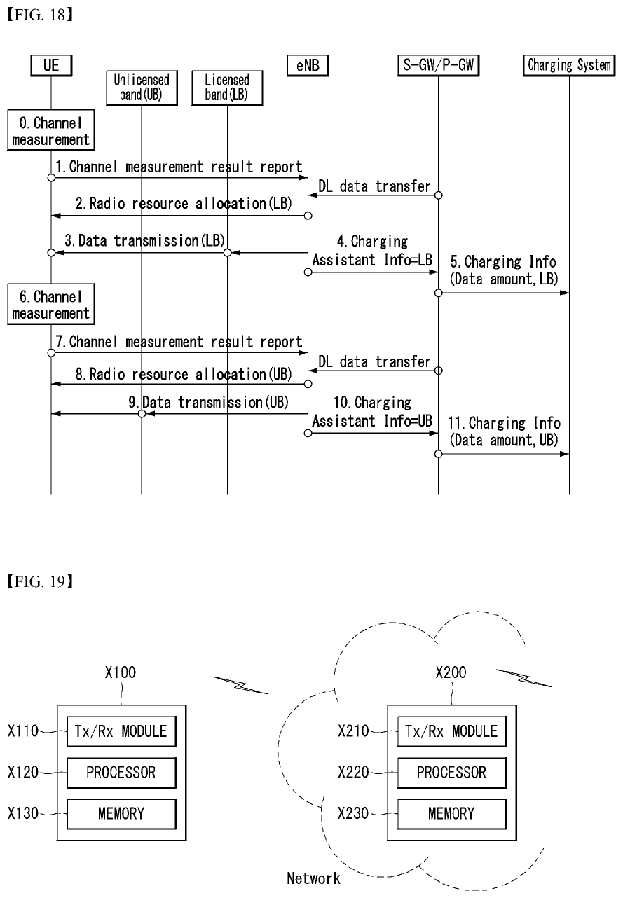

FIG. 18 illustrates another example of a procedure of transmitting/receiving data according to the present disclosure. In particular, FIG. 18 illustrates a procedure of transmitting/receiving DL data.

0. The UE measures channel quality of a licensed band (LB) and an unlicensed band (UB). The channel quality measurement by the UE may be performed periodically or at the request of the eNB.

1. The UE transfers the channel quality information measured in Step 0 to the eNB. The reporting of the channel quality information by the UE may be performed periodically or at the request of the eNB.

2. The eNB allocates radio resources for DL data transmission (transferred from 5-GW/P-GW) to the UE based on the channel quality information received in Step 1. For example, the eNB may notify the UE that data is to be transmitted through the LB.

After completing this step, when the UE is able to receive DL data through the LB, the UE may display charging information (i.e. charging information for data usage when receiving the DL data through the LB) using a pop-up window or the like.

3. The UE receives data through the radio resource indicated in Step 2. For example, when the eNB notifies the UE that data is to be transmitted through the LB, that is, when the LB is allocated as a DL data transmission resource, the UE receives UL data through the LB, as indicated in Step 2.

4. The eNB transfers charging assistance information for the DL data transmitted in Step 3 to the S-GW/P-GW. For example, the eNB provides charging assistance information indicating that the corresponding DL data has been transmitted through the LB to the P-GW through the S-GW.

5. The S-GW/P-GW transfers information indicating that the corresponding DL data has been transferred using the LB together with information on the amount of transferred DL data to the charging system using the charging assistance information for the DL data transferred from the S-GW/P-GW to the eNB.

6. The UE measures the channel quality of the LB and the UB again. The channel quality measurement by the UE may be performed periodically or at the request of the eNB.

7. The eNB allocates radio resources for DL data transmission (transferred from 5-GW/P-GW) to the UE based on the channel quality information received in Step 6. For example, the eNB may notify the UE that data is to be transmitted through the UB.

After completing this step, when the UE is able to receive the DL data through the UB, the UE may display charging information (i.e. charging information for data usage when receiving the DL data through the UB) using a pop-up window or the like.

8. The UE transmits the DL data through the radio resource indicated in Step 7. For example, when the eNB notifies the UE that data is to be transmitted through the UB, that is, when the UB is allocated as data transmission resources, the UE transmits the DL data through the UB, as indicated in Step 7.

9. The UE receives the DL data through the UB as indicated in Step 8.

10. The eNB transfers charging assistance information for the DL data transmitted in Step 9 to the S-GW/P-GW. For example, the eNB provides charging assistance information indicating that the corresponding DL data has been transmitted through the UB to the P-GW through the S-GW,

11. The S-GW/P-GW transfers information indicating that the corresponding DL data has been transferred using the UB together with information on the amount of transferred DL data to the charging system using the charging assistance information for the DL data transferred from the S-GW/P-GW to the eNB.

On the other hand, in the embodiment according to FIGS. 17 and 18 above, when the UE has finished transmitting UL data and/or receiving DL data through the LB (that is, when the UE is disconnected from the base station through the LB), the UE may display data usage information (i.e., data usage when transmitting UL data and/or data usage when receiving DL data through LB) using a pop-up window or the like. In addition, similarly, in the embodiment according to FIGS. 17 and 18 above, when the UE has finished transmitting UL data and/or receiving DL data through the UB (that is, when the UE is disconnected from the base station through the UB), the UE may display data usage information (i.e., data usage when transmitting UL data and/or data usage when receiving DL data through UB) using a pop-up window or the like.

In addition, in the embodiment according to FIGS. 17 and 18 above, the UE may configure whether to allow UL/DL data transmission/reception through the LB and/or UL/DL data transmission/reception through the UB by receiving input from the user. This will be described with reference to the drawings below.

FIG. 19 is a diagram illustrating a configuration of a node device applied to a proposal of the present disclosure.

A UE device X100 according to a proposed embodiment may include a transceiver X110, a processor X120, and a memory X130. The transceiver X110 may also be referred to as a radio frequency (RF) unit. The transceiver X110 may be configured to transmit various signals, data, and information to an external device, and to receive the various signals, data, and information from the external device. In addition, the transceiver X110 may be implemented separately as a transmission unit and a reception unit. The UE device X100 may be connected to the external device by wire and/or wirelessly. The processor X120 may control the overall operation of the UE device X100 and may be configured so that the UE device X100 performs a function of calculating and processing information to be transmitted and received with the external device. In addition, the processor X120 may be configured to perform the UE operation proposed in the present disclosure. The processor X120 may control the transceiver X110 to transmit data or a message according to the proposal of the present disclosure. The memory X130 may store operation-processed information and the like for a predetermined time, and may be replaced with a component such as a buffer.

Referring to FIG. 19, a network node device X200 according to the proposed embodiment may include a transceiver device X210, a processor X220, and a memory X230. The transceiver X210 may also be referred to as a radio frequency (RF) unit. The transceiver X210 may be configured to transmit various signals, data, and information to an external device, and to receive the various signals, data, and information from the external device. The network node device X200 may be connected to the external device by wire and/or wirelessly. The transceiver X210 may be implemented separately as a transmission unit and a reception unit. The processor X220 may control the overall operation of the network node device X200, and may be configured so that the network node device X200 performs a function of calculating and processing information to be transmitted and received with the external device. In addition, the processor X220 may be configured to perform the network node operation proposed in the present disclosure. The processor X220 may control the transceiver X110 to transmit data or a message to the UE or another network node according to the proposal of the present disclosure. The memory X230 may store operation-processed information and the like for a predetermined time, and may be replaced with a component such as a buffer.

In addition, the specific configurations of the UE device X100 and the network device X200 as described above may be implemented so that the above-described matters described in various embodiments of the present disclosure are independently applied or two or more embodiments are simultaneously applied, and descriptions of overlapping contents are omitted for clarity.

In the present disclosure, wireless devices may be base stations, network nodes, transmission terminals, receiving terminals, wireless devices, wireless communication devices, vehicles, vehicles equipped with autonomous driving functions, unmanned aerial vehicles (UAV), artificial intelligence (AI) modules, robots, augmented reality (AR) devices, virtual reality (VR) devices, MTC devices, IoT devices, medical devices, fintech devices (or financial devices), security devices, climate/environment devices or other devices related to the 4th industrial revolution field or 5G service, etc. For example, the UAV may be flying vehicles without humans and flying by a radio control signal. For example, the MTC device and the IoT device are devices that do not require direct human intervention or manipulation, and may be a smart meter, a vending machine, a thermometer, a smart light bulb, a door lock, and various sensors, etc. For example, the medical device is a device or structure used for the purpose of diagnosing, treating, alleviating, curing or preventing a disease or a device used for the purpose of testing, replacing or modifying a function, and may be equipment for treatment, a device for surgery, a device for (extracorporeal) diagnosis, a hearing aid, or a device for treatment, etc. For example, the security device is a device installed to prevent dangers that may occur and to maintain safety, and may be a camera, CCTV, or a black box, etc. For example, the fintech device is a device that can provide financial services such as mobile payment, and may be a payment device, a point of sales (POS), etc. For example, the climate/environment device may mean a device that monitors and predicts the climate/environment.

Mobile terminals described in the present disclosure may include mobile phones, smart phones, laptop computers, digital broadcasting terminals, personal digital assistants (PDAs), portable multimedia players (PMPs), navigation systems, slate PCs, tablet PCs, ultrabooks, wearable devices (for example, smartwatches, smart glasses, head mounted displays (HMD)), etc. Furthermore, it may be used for controlling at least one device in an Internet of Things (IoT) environment or a smart greenhouse.

However, it will be readily apparent to those skilled in the art that the configuration according to the embodiment described in the present disclosure may also be applied to fixed terminals such as digital TVs, desktop computers, and digital signage, etc. except when applicable only to mobile terminals.

In the above, embodiments related to a control method that can be implemented in a mobile terminal configured as described above have been described with reference to the accompanying drawings. It is obvious to those skilled in the art that the present disclosure can be embodied in other specific forms without departing from the spirit and essential features of the present disclosure.

The above-described embodiments of the present disclosure may be implemented by various means. For example, the embodiments of the present disclosure may be implemented by hardware, firmware, software, or a combination thereof.

In the case of hardware implementation, one embodiment of the present disclosure may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, and micro-processors, and the like.

In the case of implementation by firmware or software, one embodiment of the present disclosure may be implemented in the form of devices, procedures, functions, and the like which perform the functions or operations described above. Software codes may be stored in the memory unit and activated by the processor. The memory unit may be located inside or outside of the processor and may exchange data with the processor by using various well-known means.

The above-described present disclosure can be implemented as a computer-readable code on a medium on which a program is recorded. The computer readable medium includes all kinds of recording devices in which data that can be read by a computer system is stored. Examples of the computer readable medium may include a hard disk drive (HDD), a solid state disk (SSD), a silicon disk drive (SDD), a ROM, a RAM, a CD-ROM, a magnetic tape, a floppy disk, an optical data storage device, and the like, or be implemented in the form of a carrier wave (e.g. transmission over the internet). Also, the computer may include a processor Y120 of the terminal. Accordingly, the above detailed description should not be construed in all aspects as limiting, and be considered illustrative. The scope of the present disclosure should be determined by rational interpretation of the appended claims, and all changes within the equivalent range of the present disclosure are included in the scope of the present disclosure.

### INDUSTRIAL APPLICABILITY

The communication method as described above can be applied not only to the 3GPP system, but also to various wireless communication systems including IEEE 802.16x and 802.11x systems. Furthermore, the proposed method can be applied to a mmWave communication system using a very high frequency band.

1. A method for transmitting data of a terminal in a wireless communication system, comprising:
transmitting a maximum data usage value configured in the terminal to a first node of a network;
receiving configuration update information from the first node when a data usage value measured at a second node of the network reaches the maximum data usage value; and
updating a configuration related to data transmission based on the configuration update information,
wherein the configuration update information is information related to reconfiguration for a communication environment of the network.

2. The method of claim 1, wherein the terminal communicates using an unlicensed band or wireless fidelity (Wi-fi).

3. The method of claim 2, wherein the reconfiguration for the communication environment is for prohibiting the data transmission to the terminal using a mobile network, or for allowing only the data transmission using the unlicensed band.

4. The method of claim 2, wherein the configuration update information includes quality of service (QoS) information of a provided communication service or information on a wireless access technology allowed to the terminal.

5. The method of claim 2, wherein the configuration update information includes information notifying that quality of a communication service may be deteriorated due to the use of the unlicensed band of the terminal.

6. The method of claim 1, wherein the configuration related to the data transmission is for blocking the data transmission via up-link.

7. The method of claim 2, further comprising:
transmitting information on an access method indicating a wireless access technology applicable for use of a communication service to the first node.

8. The method of claim 7, wherein a connection between the terminal and the network is configured by the first node based on the information on the access method.

9. The method of claim 8, wherein the terminal receives a result of the connection configuration between the terminal and the network from the first node.

10. The method of claim 1, wherein the reconfiguration for the communication environment is triggered based on a policy and charging rule function (PCRF) or an online charging system (OCS)/offline charging system (OFCS) node.

11. The method of claim 1, wherein the second node is a packet data network gateway (P-GW) or a node related with a charging system.

12. The method of claim 7, wherein the information on the access method includes a priority value for a wireless access technology that can be applied to use the communication service.

13. The method of claim 12, wherein the transmitting information on the access method is transmitted in a radio resource control (RRC) connection process with a base station or in a service request process with the first node.

14. The method of claim 1, wherein the reconfiguration for the communication environment is for prohibiting the data transmission to the terminal using NR or LTE.

15. A terminal for transmitting data in a wireless communication system, comprising:
a communication module;
a display unit;
a memory; and
a processor configured to control the communication module, the display unit, and the memory,
wherein the processor is configured to:
transmit a maximum data usage value stored in the memory to a first node of a network through the communication module;
receive configuration update information from the first node through the communication module when a data usage value measured at a second node of the network reaches the maximum data usage value; and
update a configuration related to data use based on the configuration update information,
wherein the configuration update information is information related to reconfiguration for a communication environment of the network.

16. The terminal of claim 15, wherein the processor communicates using an unlicensed band or wireless fidelity (Wi-fi) through the communication module.

17. The terminal of claim 16, wherein the reconfiguration for a communication environment is for prohibiting the data transmission to the terminal using a mobile network, or for allowing only the data transmission using the unlicensed band.

18. The terminal of claim 15, wherein the configuration related to the data use is for blocking the data transmission via up-link.

19. The terminal of claim 16, wherein the processor transmits information on an access method indicating a wireless access technology applicable for use of a communication service to the first node through the communication module.

20. The terminal of claim 19, wherein the processor receives a result of the connection configuration between the terminal and the network by the first node based on the information on the access method through the communication module.
